(19) United States
(12) Patent Application Publication
(10) Pub. No.: US 2022/0182278 A1
(43) Pub. Date: Jun. 9, 2022

(54) SYSTEMS AND METHODS TO DETERMINE ROOT CAUSE OF CONNECTION FAILURES

(71) Applicant: Citrix Systems, Inc., Fort Lauderdale, FL (US)

(72) Inventors: Mahesh Vangapalli, Bangalore (IN); Mukesh Garg, Bangalore (IN); Vikramjeet Singh Sandhu, Bangalore (IN); Vivek Koni Raghuveer, Bangalore (IN)

(73) Assignee: Citrix Systems, Inc., Fort Lauderdale, FL (US)

(21) Appl. No.: 17/164,146

(22) Filed: Feb. 1, 2021

(30) Foreign Application Priority Data
Dec. 7, 2020 (IN) 202041053189

(51) Int. Cl. H04L 12/24; H04L 29/08; H04L 29/14

(52) U.S. Cl. CPC H04L 41/065; H04L 67/14; H04L 41/0677; H04L 41/064; H04L 69/40

(57) ABSTRACT

Described embodiments provide systems and method for determining a root cause of a failure of a session to an application, device or server. A failure of a session with an application can be identified. A device can generate a mapping between characteristics of data from the application associated with the failure and data from monitoring a plurality of sessions between a plurality of end points and a plurality of applications hosted by a plurality of computing devices. The device can determine, responsive to the mapping indicating an association between at least one characteristic of the data from the application and the data from the monitoring, a cause of the failure of the session with the application.

### CROSS-REFERENCE TO RELATED APPLICATION

This application claims priority to and the benefit of Indian Patent Application No. 202041053189, titled “SYSTEMS AND METHODS TO DETERMINE ROOT CAUSE OF CONNECTION FAILURES,” and filed on Dec. 7, 2020, the contents of which are hereby incorporated herein by reference in entirety for all purposes.

### BACKGROUND

In network environments, a client can access a plurality of resources or applications provided through a server. A device may monitor the client accessing the resources or applications over the network environment.

### SUMMARY

Systems and method for determining a root cause of a failure of a session to an application or device are provided herein. A device can identify a failure to launch a connection, failure to broker a connection or failure of an established connection and determine a cause and/or location on a data path that can be causing the connection failure. The device can map data received from one or more different sources, including a device (e.g., client end point) experiencing the failure, a broker or gateway device, a monitoring system and/or application (e.g., remote peer, hosted application) an end point is attempting to connect with. The data can include or identify an event corresponding to the failure and can be mapped to identify or verify a particular failure code, failure category and/or location of a failed connection. The device can map the event data from the different sources to identify associations (e.g., similarities, matches) between the data sets and determine a cause for the failure and/or which segment, system or device on a data path is causing the connection failure. In embodiments, the device can provide or generate actions to fix, address or otherwise repair the issue causing the connection failure.

In at least one aspect, a method is provided. The method can include identifying, by a device, a failure of a session with an application of a plurality of applications hosted by a computing device of a plurality of computing devices. The method can include generating, by the device, a mapping between characteristics of data from the application associated with the failure and data from monitoring a plurality of sessions between a plurality of end points and a plurality of applications hosted by the plurality of computing devices. The method can include determining, by the device responsive to the mapping indicating an association between at least one characteristic of the data from the application and the data from the monitoring, a cause of the failure of the session with the application.

In embodiments, the method can include determining, by the device, a plurality of associations between the characteristics of the data from the application and the characteristics of the data from the monitoring. The characteristics can include at least one of: a failure code, a failure category, a username associated with a user of the end point or a time value associated with the failure. The method can include determining, by the device, an event identified by the application corresponds to an event recorded by the monitoring based on the association between a category of the event, a username, and a time value associated with the event. In embodiments, the event can indicate a connection failure to the application.

The method can include determining, by the device, the association responsive to a time value of the data from the application and a time value of the data from the monitoring being within a common time range. The method can include determining, by the device, a type of connection that caused the failure of the session with the application. The type of connection can include an internal connection or an external connection. In embodiments, the cause of the failure can include at least one of: a firewall setting at an end point of the plurality of end points, a firewall setting at the application, an issue with a certificate of the end point, or an invalid ticket.

The method can include identifying, by the device, an address of a gateway device associated with the session with the application and determining, by the device, the failure occurred on a connection between the gateway and the application. The method can include updating, by the device, a database to include the data from the application and the data from the monitoring for the failure and determining, by the device responsive to the updated database, a number of failures to the application and a type of connection that failed for each failure to the application.

In at least one aspect, a system is provided. The system can include a device comprising one or more processors coupled to memory. The device can be configured to identify a failure of a session with an application of a plurality of applications hosted by a computing device of a plurality of computing devices. The device can be configured to generate a mapping between characteristics of data from the application associated with the failure and data from monitoring a plurality of sessions between a plurality of end points and the plurality of applications hosted by the plurality of computing devices. The device can be configured to determine, responsive to the mapping indicating an association between at least one characteristic of the data from the application and the data from the monitoring, a cause of the failure of the session with the application.

In embodiments, the device can be configured to determine a plurality of associations between the characteristics of the data from the application and the characteristics of the data from the monitoring. The characteristics can include at least one of: a failure code, a failure category, a username associated with a user of the end point or a time value associated with the failure. The device can be configured to determine an event identified by the application corresponds to an event recorded by the monitoring service based on a match between a category of the event, a username, and a time value associated with the event, wherein the event indicates a connection failure to the application. The device can be configured to determine the association responsive to a time value of the data from the application and a time value of the data from the monitoring being within a common time range. The device can be configured to determine a type of connection that caused the failure of the session with the application. The type of connection can include an internal connection or an external connection.

In embodiments, the device can be configured to determine the cause of the failure includes at least one of: a firewall setting at an end point of the plurality of end points, a firewall setting at the application, an issue with a certificate of the end point, or an invalid ticket. The device can be configured to identify an address of a gateway device associated with the session with the application and determine the failure occurred on a connection between the gateway and the application. The device can be configured to update a database to include the data from the application and the data from the monitoring for the failure and determine, responsive to the updated database, a number of failures to the application and a type of connection that failed for each failure to the application.

In at least one aspect, a non-transitory computer-readable medium is provided. The non-transitory computer-readable medium can include instructions that, when executed by the processor of a device, cause the processor to identify a failure of a session with an application of a plurality of applications hosted by a computing device of a plurality of computing devices. The non-transitory computer-readable medium can include instructions that, when executed by the processor of a device, cause the processor to generate a mapping between characteristics of data from the application associated with the failure and data from monitoring a plurality of sessions between a plurality of end points and the plurality of applications hosted by the plurality of computing devices. The non-transitory computer-readable medium can include instructions that, when executed by the processor of a device, cause the processor to determine, responsive to the mapping indicating an association between at least one characteristic of the data from the application and the data from the monitoring, a cause of the failure of the session with the application.

In embodiments, the non-transitory computer-readable medium can include instructions that, when executed by the processor of a device, cause the processor to determine a plurality of associations between the characteristics of the data from the application and the characteristics of the data from the monitoring. The characteristics can include at least one of: a failure code, a failure category, a username associated with a user of the end point or a time value associated with the failure.

The details of various embodiments of the disclosure are set forth in the accompanying drawings and the description below.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of embodiments of a computing device;

FIG. 1B is a block diagram depicting a computing environment comprising client device in communication with cloud service providers;

FIG. 2A is a block diagram of an example system in which resource management services may manage and streamline access by clients to resource feeds (via one or more gateway services) and/or software-as-a-service (SaaS) applications;

FIG. 2B is a block diagram showing an example implementation of the system shown in FIG. 2A in which various resource management services as well as a gateway service are located within a cloud computing environment;

FIG. 2C is a block diagram similar to that shown in FIG. 2B but in which the available resources are represented by a single box labeled “systems of record,” and further in which several different services are included among the resource management services;

FIG. 3 is a block diagram of a system for determining a cause of a failure of a session to an application, in accordance with an illustrative embodiment;

FIG. 4 is a flow diagram of a method for aggregating data from an application to data from a monitoring service, in accordance with an illustrative embodiment; and

FIGS. 5A-5B are a flow diagram of a method for mapping data from an application to data from a monitoring service, in accordance with an illustrative embodiment.

### DETAILED DESCRIPTION

Systems and methods for determining a cause of a failure of a connection to an application or computing device is provided herein. A device can identify a failure of a session with an application, computing device, server or hosted computing device. The failure of the session can include a failure to launch a connection, broker a connection or the failure of an established connection. The device can receive data from an application or device associated with the failed connection and a monitoring service monitoring a plurality of sessions between end points (e.g., client devices), hosted machines, hosted applications and/or gateway devices. A mapping can be generated between characteristics of the data from the different sources to determine if the data is associated with or corresponds to the same event or similar event. The mapping can include one or more associations (e.g., matches, similarities) between the different data sets, including but not limited to, similar failure codes, similar failure categories, and/or similar time values. The device can use the mapping and identified associations to determine a cause for the failure and/or a location (e.g., location on a data path, type of connection) of the failure. In embodiments, the device can generate one or more actions for a device or application to perform or apply to correct or otherwise address the cause of the failure.

Session failures can result in poor user experiences for users attempting to access or launch a connection to applications or hosted computing devices. In embodiments, the session attempt can include external components or client side components, internal components, server side components, public network components and/or private network components, thus making it difficult to determine a root cause for a failure and/or a location of the failure. For example, a session failure can be caused by client side (e.g., client device, client application) communication failures, including but not limited to, a connection timeout, network security issues, or invalid certificate. A system or administrator brokering or monitoring the sessions may not be able to determine whether the failure was caused by client side issues or server or hosted device (e.g., virtual machine, virtual desktop) issues. A system or administrator brokering or monitoring the sessions may not be able to determine if the failure occurred to an internal connection, external connection, a data path between end point (e.g., client device) and a hosted application or remote device, a data path between a gateway device and a hosted application or a remote device.

The systems and methods described herein can determine a cause for a failure and/or a location of the failure, for example, on a data path between an end point and hosted computing device, server or gateway device. Data points can be collected from multiple different sources and correlated to verify that a failure occurred and determine a root cause of the failure. A mapping can be generated indicating associations between characteristics or attributes of the different data points to correlate metrics or information recorded at the different sources. In some embodiments, the mapping can be used to determine if events recorded or monitored at different devices are the same event or similar event. The mapping can link the data points from different sources, including but not limited to, a client device, gateway/broker device (e.g., brokering logic), traffic proxy, server, hosted computing device and/or hosted application, to generate a more accurate picture of what caused the failure and/or where the failure occurred. Actions or recommendations can be generated to address, fix or otherwise correct the issue causing the failure. In some embodiments, the actions or recommendations can be provided to a device, for example, for a user or admin to address the issue causing the failure based in part on the received action or recommendation. In some embodiments, the system can be automated such that actions or recommendations can be applied to one or more devices operating to launch a session to address the failure in real-time and allow or provide for the session to be launched.

A device or event system can collect, request or receive data from multiple different sources and maintain metrics on failures across a plurality of sessions. The sessions can include any type of connection or communication system including an end point (e.g., client device) accessing a remote or hosted device (e.g., virtual application, virtual agent, virtual machine, a traffic proxy or gateway device, a control or brokering logic for establishing and maintaining communication sessions. The sessions can include hosted sessions, virtual sessions or voice over internet protocol (VOIP) based sessions. In embodiments, the sessions can include a connection between a client device and a hosted application provided by a hosted computing device or server. In some embodiments, the sessions can include a connection between a gateway device and a hosted application provided by a hosted computing device or server.

The device can receive the data from the devices or computing systems included in the connection (e.g., client device, gateway device, hosted device) and/or a monitoring system executing in a network to monitor the one or more sessions. The data can include or be provided in the form of event data or event streams. The device can analyze and filter the event streams to determine associations between data points received from different sources. The device can map and correlate metrics included with the data and event stream, including but not limited to, a failure code, failure category, time values (e.g., time stamps), username, device address information, and type of connection (e.g., external connection, internal connection).

In embodiments, the device can map individual characteristics of the data sets received from the different sources to confirm or verify an event and/or cause of a failure. The device can map a failure category for an event recorded at a first source (e.g., monitoring service) to a failure category for an event recorded at a second source (e.g., hosted application) to verify the event (e.g., failure to launch a session) occurred. The device can map additional characteristics from the data sets received from the different sources to confirm and/or verify additional information associated with the event. In some embodiments, the device can map a failure code for the event recorded at the first source to the failure code for the event recorded at the second source and time value for both data sets. The mapping can be generated to indicate a type of connection that caused the event, such as, an internal connection or external connection. The device can use the mapping and the type of connection determine the cause of the event (e.g., failure) and generate one or more actions to correct or address the failure.

In embodiments, the cause or reason for a failure can include, but is not limited to, firewall settings on end point or branch office, firewall settings enabled on application (e.g., virtual application, hosted application), connection rejected by server or gateway device, connection failed due to certificate issue, or invalid ticket (e.g., secure ticket authority (STA) ticket). The device can generate actions to update or modify firewall settings, network connection settings, certificate settings and/or ticket information.

The mapping and event data can be maintained and stored in an event database based in part on the respective event and the characteristics of the data. The event database can maintain a mapping for individual characteristics (e.g., failure category, causes, failure codes, type of connection, IP address information) to determine patterns or predictions to prevent future or subsequent failures for events having similar characteristics. The mappings can be used to determine a number of failures for different end points, gateway devices, servers, hosted devices, and/or hosted applications. In embodiments, the mappings can be used to determine a number of failures on connections between an end point and a hosted application, a gateway device and a hosted application and/or a number of failures on external connections or internal connections.

In some embodiments, the mapping between the data sets and mappings between the characteristics can be graphed or provided through an interface (e.g., graphical user interface) of a device. The mappings can be generated and displayed through the interface for a user or admin to receive notifications including actions or recommendations to correct failures, provide warnings for potential failures and/or illustrate where failures are occurring in a network or for a user.

The data sets can be received from the different sources as the events occur (e.g., in real-time) or as streamed data, for example, through a streaming layer. In one embodiments, the device can include or connect to a streaming application to receive the streaming data and correlate the data from the different sources to generate the mappings. In some embodiments, the streaming application can perform the correlation and mapping in batches or based in part on time ranges to correlate data having similar time values (e.g., time stamps within a common time range). The streaming application can request or extract data from a monitoring service for a particular time range to compare with steamed data received from one or more sources and determine events associated with the received data.

In some embodiments, the characteristics between the data sets can be compared in a determined order to determine a mapping for an event and then determine a cause and/or location of the failure associated with the event. In one embodiments, the device can compare a failure category characteristic and a username characteristic from the different data sets to determine or identify a mapping between the events indicated by the data sets. The device can compare time values (e.g., failure time, event time) of the data sets to determine if the events correspond to the same or similar events. In embodiments, if the time values are within a common time grange or a time different between the time values is less than a threshold, the device can determine the events correspond to the same or similar events. The device can determine if a traffic proxy or gateway device was used in the connection based in part on if the data sets include address information (e.g., IP address) for a traffic proxy or gateway device. In one embodiment, if address information for a traffic proxy or gateway device is included with the data, the device can determine the failure occurred on a data path between the gateway device and a hosted application. In one embodiment, if address information for a traffic proxy or gateway device is not included with the data, the device can determine the failure occurred on a data path between an end point and a hosted application. The device can determine, using the mapping, whether the failure occurred to an internal connection (e.g., connection through a private network) or an external connection (e.g., connection through a public network). In embodiments, the device can use the mapping to determine a cause or reason for the failure.

Section A describes a computing environment which may be useful for practicing embodiments described herein.

Section B describes methods and systems for determining root cause of connection failures to applications.

### A. Computing Environment

Prior to discussing the specifics of embodiments of the systems and methods of for securing offline data (e.g., browser offline data) for shared accounts, it may be helpful to discuss the computing environments in which such embodiments may be deployed.

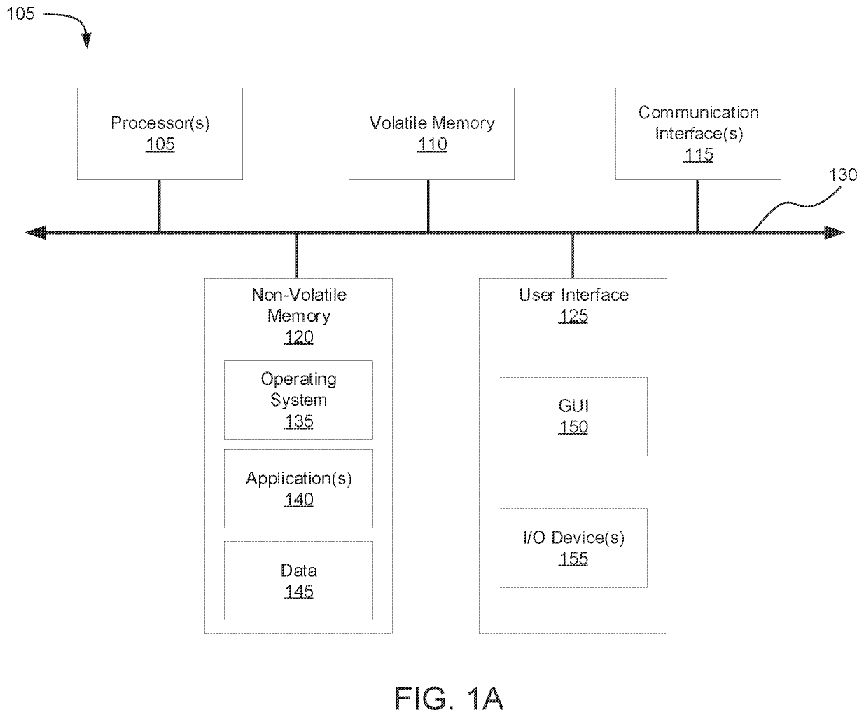

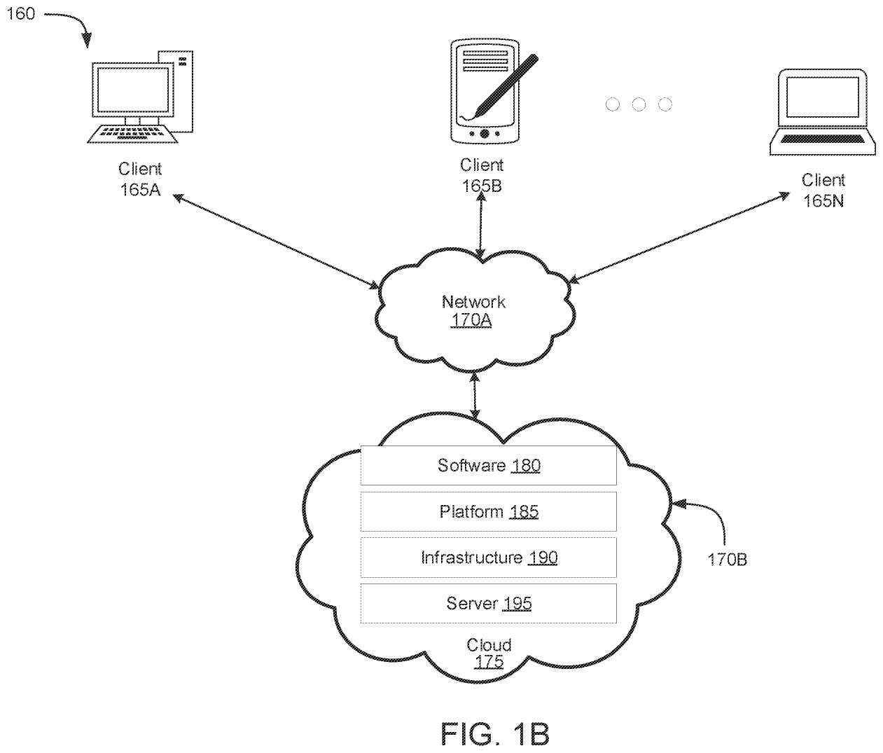

As shown in FIG. 1A, computer 100 may include one or more processors 105, volatile memory 110 (e.g., random access memory (RAM)), non-volatile memory 120 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 125, one or more communications interfaces 115, and communication bus 130. User interface 125 may include graphical user interface (GUI) 150 (e.g., a touchscreen, a display, etc.) and one or more input/output (I/O) devices 155 (e.g., a mouse, a keyboard, a microphone, one or more speakers, one or more cameras, one or more biometric scanners, one or more environmental sensors, one or more accelerometers, etc.). Non-volatile memory 120 stores operating system 135, one or more applications 140, and data 145 such that, for example, computer instructions of operating system 135 and/or applications 140 are executed by processor(s) 105 out of volatile memory 110. In some embodiments, volatile memory 110 may include one or more types of RAM and/or a cache memory that may offer a faster response time than a main memory. Data may be entered using an input device of GUI 150 or received from I/O device(s) 155. Various elements of computer 100 may communicate via one or more communication buses, shown as communication bus 130.

Computer 100 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 105 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 115 may include one or more interfaces to enable computer 100 to access a computer network such as a Local Area Network (LAN), a Wide Area Network (WAN), a Personal Area Network (PAN), or the Internet through a variety of wired and/or wireless or cellular connections.

In described embodiments, the computing device 100 may execute an application on behalf of a user of a client computing device. For example, the computing device 100 may execute a virtual machine, which provides an execution session within which applications execute on behalf of a user or a client computing device, such as a hosted desktop session. The computing device 100 may also execute a terminal services session to provide a hosted desktop environment. The computing device 100 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but are not limited to, networks, network bandwidth, servers 195, processing, memory, storage, applications, virtual machines, databases, software, hardware, analytics, and intelligence.

In embodiments, the computing environment 160 may provide client 165 with one or more resources provided by a network environment. The computing environment 160 may include one or more clients 165a-165n, in communication with a cloud 175 over one or more networks 170A, 170B. Clients 165 may include, e.g., thick clients, thin clients, and zero clients. The cloud 175 may include back end platforms, e.g., servers 195, storage, server farms or data centers. The clients 165 can be the same as or substantially similar to computer 100 of FIG. 1A.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 175 may be public, private, or hybrid. Public clouds 175 may include public servers 195 that are maintained by third parties to the clients 165 or the owners of the clients 165. The servers 195 may be located off-site in remote geographical locations as disclosed above or otherwise. Public clouds 175 may be connected to the servers 195 over a public network 170. Private clouds 175 may include private servers 195 that are physically maintained by clients 165 or owners of clients 165. Private clouds 175 may be connected to the servers 195 over a private network 170. Hybrid clouds 175 may include both the private and public networks 170A, 170B and servers 195.

The cloud 175 may include back end platforms, e.g., servers 195, storage, server farms or data centers. For example, the cloud 175 can include or correspond to a server 195 or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g. Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 165 may also access SaaS resources through smartphone or tablet applications, including, e.g., Salesforce Sales Cloud, or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

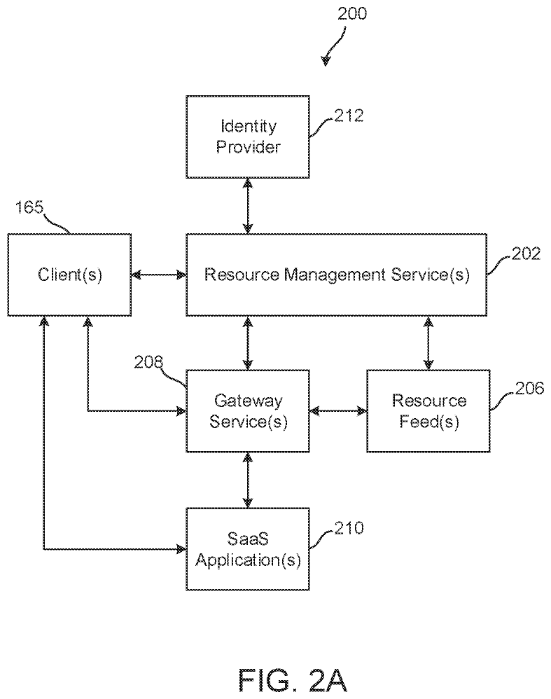

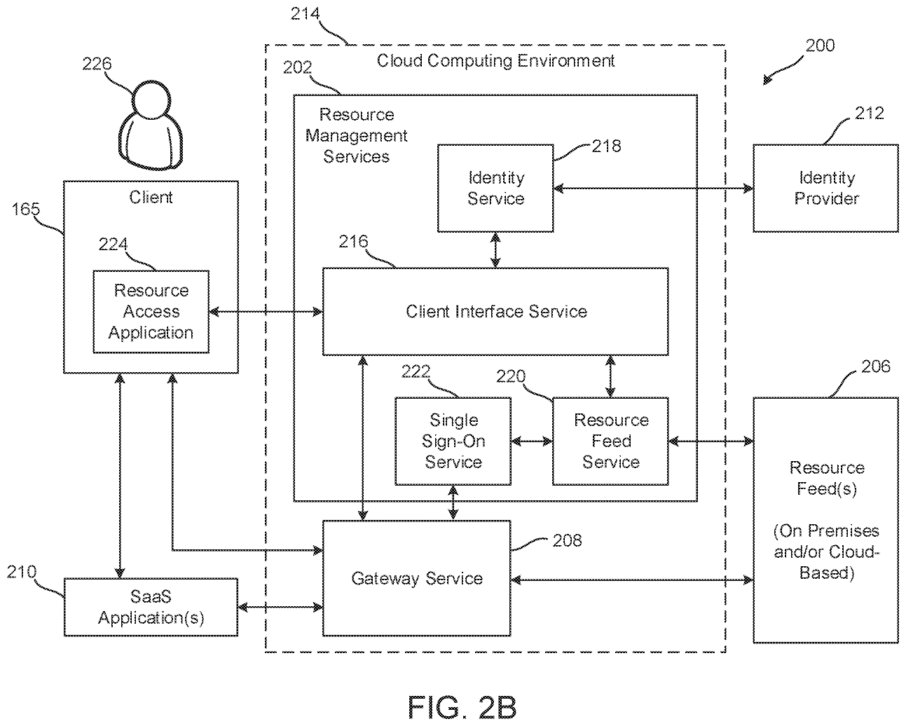

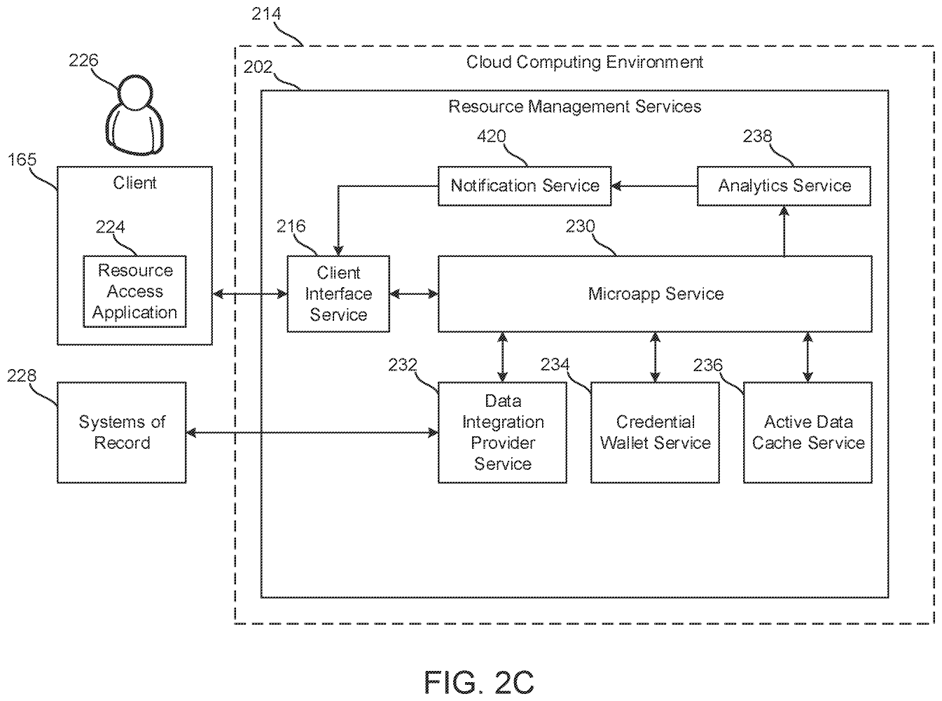

FIG. 2A is a block diagram of an example system 200 in which one or more resource management services 202 may manage and streamline access by one or more clients 165 to one or more resource feeds 206 (via one or more gateway services 208) and/or one or more software-as-a-service (SaaS) applications 210. In particular, the resource management service(s) 202 may employ an identity provider 212 to authenticate the identity of a user of a client 165 and, following authentication, identify one of more resources the user is authorized to access. In response to the user selecting one of the identified resources, the resource management service(s) 202 may send appropriate access credentials to the requesting client 165, and the client 165 may then use those credentials to access the selected resource. For the resource feed(s) 206, the client 165 may use the supplied credentials to access the selected resource via a gateway service 208. For the SaaS application(s) 210, the client 165 may use the credentials to access the selected application directly.

The client(s) 165 may be any type of computing devices capable of accessing the resource feed(s) 206 and/or the SaaS application(s) 210, and may, for example, include a variety of desktop or laptop computers, smartphones, tablets, etc. The resource feed(s) 206 may include any of numerous resource types and may be provided from any of numerous locations. In some embodiments, for example, the resource feed(s) 206 may include one or more systems or services for providing virtual applications and/or desktops to the client(s) 165, one or more file repositories and/or file sharing systems, one or more secure browser services, one or more access control services for the SaaS applications 210, one or more management services for local applications on the client(s) 165, one or more internet enabled devices or sensors, etc. Each of the resource management service(s) 202, the resource feed(s) 206, the gateway service(s) 208, the SaaS application(s) 210, and the identity provider 212 may be located within an on-premises data center of an organization for which the system 200 is deployed, within one or more cloud computing environments, or elsewhere.

FIG. 2B is a block diagram showing an example implementation of the system 200 shown in FIG. 2A in which various resource management services 202 as well as a gateway service 208 are located within a cloud computing environment 214. The cloud computing environment may, for example, include Microsoft Azure Cloud, Amazon Web Services, Google Cloud, or IBM Cloud.

For any of illustrated components (other than the client 165) that are not based within the cloud computing environment 214, cloud connectors (not shown in FIG. 2B) may be used to interface those components with the cloud computing environment 214. Such cloud connectors may, for example, run on Windows Server instances hosted in resource locations and may create a reverse proxy to route traffic between the site(s) and the cloud computing environment 214. In the illustrated example, the cloud-based resource management services 202 include a client interface service 216, an identity service 218, a resource feed service 220, and a single sign-on service 222. As shown, in some embodiments, the client 165 may use a resource access application 224 to communicate with the client interface service 216 as well as to present a user interface on the client 165 that a user 226 can operate to access the resource feed(s) 206 and/or the SaaS application(s) 210. The resource access application 224 may either be installed on the client 165, or may be executed by the client interface service 216 (or elsewhere in the system 200) and accessed using a web browser (not shown in FIG. 2B) on the client 165.

As explained in more detail below, in some embodiments, the resource access application 224 and associated components may provide the user 226 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 224 is launched or otherwise accessed by the user 226, the client interface service 216 may send a sign-on request to the identity service 218. In some embodiments, the identity provider 212 may be located on the premises of the organization for which the system 200 is deployed. The identity provider 212 may, for example, correspond to an on-premises Windows Active Directory. In such embodiments, the identity provider 212 may be connected to the cloud-based identity service 218 using a cloud connector (not shown in FIG. 2B), as described above. Upon receiving a sign-on request, the identity service 218 may cause the resource access application 224 (via the client interface service 216) to prompt the user 226 for the user's authentication credentials (e.g., user-name and password). Upon receiving the user's authentication credentials, the client interface service 216 may pass the credentials along to the identity service 218, and the identity service 218 may, in turn, forward them to the identity provider 212 for authentication, for example, by comparing them against an Active Directory domain. Once the identity service 218 receives confirmation from the identity provider 212 that the user's identity has been properly authenticated, the client interface service 216 may send a request to the resource feed service 220 for a list of subscribed resources for the user 226.

In other embodiments (not illustrated in FIG. 2B), the identity provider 212 may be a cloud-based identity service, such as a Microsoft Azure Active Directory. In such embodiments, upon receiving a sign-on request from the client interface service 216, the identity service 218 may, via the client interface service 216, cause the client 165 to be redirected to the cloud-based identity service to complete an authentication process. The cloud-based identity service may then cause the client 165 to prompt the user 226 to enter the user's authentication credentials. Upon determining the user's identity has been properly authenticated, the cloud-based identity service may send a message to the resource access application 224 indicating the authentication attempt was successful, and the resource access application 224 may then inform the client interface service 216 of the successfully authentication. Once the identity service 218 receives confirmation from the client interface service 216 that the user's identity has been properly authenticated, the client interface service 216 may send a request to the resource feed service 220 for a list of subscribed resources for the user 226.

For each configured resource feed, the resource feed service 220 may request an identity token from the single sign-on service 222. The resource feed service 220 may then pass the feed-specific identity tokens it receives to the points of authentication for the respective resource feeds 206. Each resource feed 206 may then respond with a list of resources configured for the respective identity. The resource feed service 220 may then aggregate all items from the different feeds and forward them to the client interface service 216, which may cause the resource access application 224 to present a list of available resources on a user interface of the client 165. The list of available resources may, for example, be presented on the user interface of the client 165 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 165, and/or one or more SaaS applications 210 to which the user 226 has subscribed. The lists of local applications and the SaaS applications 210 may, for example, be supplied by resource feeds 206 for respective services that manage which such applications are to be made available to the user 226 via the resource access application 224. Examples of SaaS applications 210 that may be managed and accessed as described herein include Microsoft Office 365 applications, SAP SaaS applications, Workday applications, etc.

For resources other than local applications and the SaaS application(s) 210, upon the user 226 selecting one of the listed available resources, the resource access application 224 may cause the client interface service 216 to forward a request for the specified resource to the resource feed service 220. In response to receiving such a request, the resource feed service 220 may request an identity token for the corresponding feed from the single sign-on service 222. The resource feed service 220 may then pass the identity token received from the single sign-on service 222 to the client interface service 216 where a launch ticket for the resource may be generated and sent to the resource access application 224. Upon receiving the launch ticket, the resource access application 224 may initiate a secure session to the gateway service 208 and present the launch ticket. When the gateway service 208 is presented with the launch ticket, it may initiate a secure session to the appropriate resource feed and present the identity token to that feed to seamlessly authenticate the user 226. Once the session initializes, the client 165 may proceed to access the selected resource.

When the user 226 selects a local application, the resource access application 224 may cause the selected local application to launch on the client 165. When the user 226 selects a SaaS application 210, the resource access application 224 may cause the client interface service 216 request a one-time uniform resource locator (URL) from the gateway service 208 as well a preferred browser for use in accessing the SaaS application 210. After the gateway service 208 returns the one-time URL and identifies the preferred browser, the client interface service 216 may pass that information along to the resource access application 224. The client 165 may then launch the identified browser and initiate a connection to the gateway service 208. The gateway service 208 may then request an assertion from the single sign-on service 222. Upon receiving the assertion, the gateway service 208 may cause the identified browser on the client 165 to be redirected to the logon page for identified SaaS application 210 and present the assertion. The SaaS may then contact the gateway service 208 to validate the assertion and authenticate the user 226. Once the user has been authenticated, communication may occur directly between the identified browser and the selected SaaS application 210, thus allowing the user 226 to use the client 165 to access the selected SaaS application 210.

In some embodiments, the preferred browser identified by the gateway service 208 may be a specialized browser embedded in the resource access application 224 (when the resource application is installed on the client 165) or provided by one of the resource feeds 206 (when the resource application 224 is located remotely), e.g., via a secure browser service. In such embodiments, the SaaS applications 210 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 165 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 206) for assessment of its security risk by a web filtering service. For approved URLs, the specialized browser may be permitted to access the link. For suspicious links, however, the web filtering service may have the client interface service 216 send the link to a secure browser service, which may start a new virtual browser session with the client 165, and thus allow the user to access the potentially harmful linked content in a safe environment.

In some embodiments, in addition to or in lieu of providing the user 226 with a list of resources that are available to be accessed individually, as described above, the user 226 may instead be permitted to choose to access a streamlined feed of event notifications and/or available actions that may be taken with respect to events that are automatically detected with respect to one or more of the resources. This streamlined resource activity feed, which may be customized for each user 226, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 165 to notify a user 226 of something that requires the user's attention (e.g., approval of an expense report, new course available for registration, etc.).

FIG. 2C is a block diagram similar to that shown in FIG. 2B but in which the available resources (e.g., SaaS applications, web applications, Windows applications, Linux applications, desktops, file repositories and/or file sharing systems, and other data) are represented by a single box 228 labeled “systems of record,” and further in which several different services are included within the resource management services block 202. As explained below, the services shown in FIG. 2C may enable the provision of a streamlined resource activity feed and/or notification process for a client 165. In the example shown, in addition to the client interface service 216 discussed above, the illustrated services include a microapp service 230, a data integration provider service 232, a credential wallet service 234, an active data cache service 236, an analytics service 238, and a notification service 240. In various embodiments, the services shown in FIG. 2C may be employed either in addition to or instead of the different services shown in FIG. 2B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 224 without having to launch the native application. The system shown in FIG. 2C may, for example, aggregate relevant notifications, tasks, and insights, and thereby give the user 226 a dynamic productivity tool. In some embodiments, the resource activity feed may be intelligently populated by utilizing machine learning and artificial intelligence (AI) algorithms. Further, in some implementations, microapps may be configured within the cloud computing environment 214, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 2C, the systems of record 228 may represent the applications and/or other resources the resource management services 202 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 202, and in particular the data integration provider service 232, may, for example, support REST API, JSON, OData-JSON, and 6ML. As explained in more detail below, the data integration provider service 232 may also write back to the systems of record, for example, using OAuth2 or a service account.

In some embodiments, the microapp service 230 may be a single-tenant service responsible for creating the microapps. The microapp service 230 may send raw events, pulled from the systems of record 228, to the analytics service 238 for processing. The microapp service may, for example, periodically pull active data from the systems of record 228.

In some embodiments, the active data cache service 236 may be single-tenant and may store all configuration information and microapp data. It may, for example, utilize a per-tenant database encryption key and per-tenant database credentials.

In some embodiments, the credential wallet service 234 may store encrypted service credentials for the systems of record 228 and user OAuth2 tokens.

In some embodiments, the data integration provider service 232 may interact with the systems of record 228 to decrypt end-user credentials and write back actions to the systems of record 228 under the identity of the end-user. The write-back actions may, for example, utilize a user's actual account to ensure all actions performed are compliant with data policies of the application or other resource being interacted with.

In some embodiments, the analytics service 238 may process the raw events received from the microapps service 230 to create targeted scored notifications and send such notifications to the notification service 240.

Finally, in some embodiments, the notification service 240 may process any notifications it receives from the analytics service 238. In some implementations, the notification service 240 may store the notifications in a database to be later served in a notification feed. In other embodiments, the notification service 240 may additionally or alternatively send the notifications out immediately to the client 165 as a push notification to the user 226.

In some embodiments, a process for synchronizing with the systems of record 228 and generating notifications may operate as follows. The microapp service 230 may retrieve encrypted service account credentials for the systems of record 228 from the credential wallet service 234 and request a sync with the data integration provider service 232. The data integration provider service 232 may then decrypt the service account credentials and use those credentials to retrieve data from the systems of record 228. The data integration provider service 232 may then stream the retrieved data to the microapp service 230. The microapp service 230 may store the received systems of record data in the active data cache service 236 and also send raw events to the analytics service 238. The analytics service 238 may create targeted scored notifications and send such notifications to the notification service 240. The notification service 240 may store the notifications in a database to be later served in a notification feed and/or may send the notifications out immediately to the client 165 as a push notification to the user 226.

In some embodiments, a process for processing a user-initiated action via a microapp may operate as follows. The client 165 may receive data from the microapp service 230 (via the client interface service 216) to render information corresponding to the microapp. The microapp service 230 may receive data from the active data cache service 236 to support that rendering. The user 226 may invoke an action from the microapp, causing the resource access application 224 to send that action to the microapp service 230 (via the client interface service 216). The microapp service 230 may then retrieve from the credential wallet service 234 an encrypted Oauth2 token for the system of record for which the action is to be invoked, and may send the action to the data integration provider service 232 together with the encrypted Oath2 token. The data integration provider service 232 may then decrypt the Oath2 token and write the action to the appropriate system of record under the identity of the user 226. The data integration provider service 232 may then read back changed data from the written-to system of record and send that changed data to the microapp service 230. The microapp service 232 may then update the active data cache service 236 with the updated data and cause a message to be sent to the resource access application 224 (via the client interface service 216) notifying the user 226 that the action was successfully completed.

In some embodiments, in addition to or in lieu of the functionality described above, the resource management services 202 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 202 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 202 may, for example, parse these requests and respond because they are integrated with multiple systems on the back-end. In some embodiments, users may be able to interact with the virtual assistance through either the resource access application 224 or directly from another resource, such as Microsoft Teams. This feature may allow employees to work efficiently, stay organized, and deliver only the specific information they're looking for.

### B. Methods and Systems for Determining Root Cause of Connection Failures to Applications

Systems and method for determining a root cause of a failure of a session to an application, device or server are provided herein. Failures to establish a connection to an application, device, server or over any communications system (e.g., VOIP system) can be identified and a cause for the failure can be determined by mapping characteristics of data from multiple different sources. In embodiments, a device can identify a failure to launch a connection, failure to broker a connection or failure of an established connection and determine a cause and/or location on a data path that can be causing the connection failure. The device can map data received from one or more different sources, including a device (e.g., client end point) experiencing the failure, a broker or gateway device, a monitoring system and/or application (e.g., remote peer, hosted application) an end point is attempting to connect with. The data can include or identify an event corresponding to the failure and can be mapped to identify or verify a particular failure code, failure category and/or location of a failed connection. The device can map the event data from the different sources to identify associations (e.g., similarities, matches) between the data sets and determine a cause for the failure and/or which segment, system or device on a data path is causing the connection failure. In embodiments, the device can provide or generate actions to fix, address or otherwise repair the issue causing the connection failure.

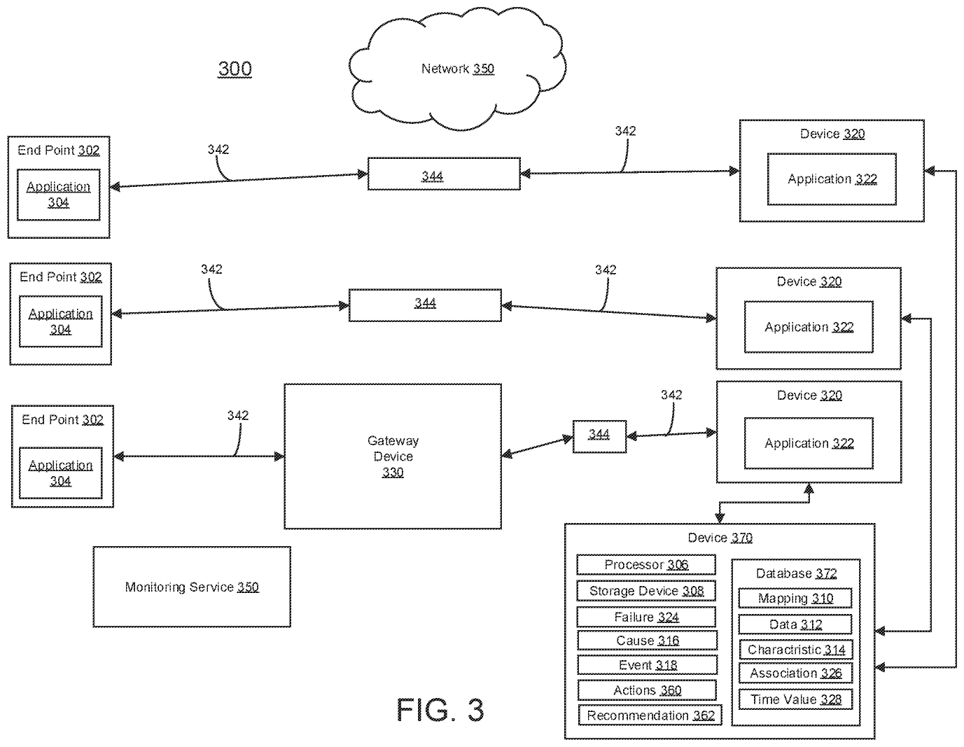

Referring now to FIG. 3, depicted is a block diagram of a system 300 having a plurality of end points 302 and a plurality of applications 322 hosted by a plurality of computing devices 320. The end points 302 can access or establish a session 344 to the hosted applications 322, for example, through a client application 304 of the respective end point 302. In some embodiments, the end points 302 can establish a session 344 to the hosted applications 322 through a gateway device 330. The system 300 can include a monitoring service 350 executing with the same network 340 or different network 340 and monitoring and/or recording data 312 associated with the sessions 344 or attempted sessions 344 to the hosted applications 322. In embodiments, the end points 302 may experience events 318 corresponding to failures 324 during sessions 344 to the hosted applications 322 and/or failures 324 to launch a session 344 to a hosted application 322 including failures 324.

A device 370 can collect or receive the data 312 associated with the events 318 and failures 324 from different sources, including but not limited to, end points 302, client applications 304, hosted applications 322, computing devices 320 and monitoring service 350, and correlate the data 312 from the different sources to determine one or more associations 326 between the data 312. The device 370 can use the associations 326 to determine a cause 316 for a failure 324, a type of connection 342 that failed and/or an action 360 to correct or address the failure 324.

The end point 302 can include a client device 302, a computing device or a mobile device. The end point 302 can include or correspond to an instance of any client device, mobile device or computer device described herein. For example, the end point 302 can be the same as or substantially similar to computer 100 of FIG. 1A, and/or client 165 of FIG. 1B-2C. The end point 302 can be implemented using hardware or a combination of software and hardware. For example, components of the end point 302 can include logical circuitry (e.g., a central processing unit or CPU) that responds to and processes instructions fetched from a memory unit (e.g., storage device 308). Components of the end point 302 can include or use a microprocessor or a multi-core processor. A multi-core processor can include two or more processing units (e.g., processor 306) on a single computing component. Components of the end point 302 can be based on any of these processors, or any other processor capable of operating as described herein. Processors can utilize instruction level parallelism, thread level parallelism, different levels of cache, etc. For example, the end point 302 can include at least one logic device such as a computing device or server having at least one processor 306 to communicate. The components and elements of the end point 302 can be separate components or a single component. The end point 302 can include a memory component (e.g., storage device 308) to store and retrieve data (e.g., data 312, events 318). The memory can include a random access memory (RAM) or other dynamic storage device, coupled with the storage device 308 for storing information, and instructions to be executed by the end point 302. The memory can include at least one read only memory (ROM) or other static storage device coupled with the storage device 308 for storing static information and instructions for the end point 302. The memory can include a storage device 308, such as a solid state device, magnetic disk or optical disk, to persistently store information and instructions.

The end point 302 can include a processor 306. The processor 306 can include non-volatile memory that stores computer instructions and an operating system. For example, the computer instructions can be executed by the processor 306 out of volatile memory to perform all or part of the methods 400 and/or 500. In some embodiments, the end point 302 can include a non-transitory computer-readable medium, comprising instructions that, when executed by the processor 306 of the end point 302, cause the processor 306 to perform all or part of the methods 400 and/or 500. The processor 306 can be the same as or substantially similar to processor 105 of FIG. 1A.

The end point 302 can include or execute an application 304 (referred to herein as client application 304). The client application 304 can include resources, desktops, and or files. In embodiments, the client application 304 can include local applications (e.g., local to a client device 302), hosted applications, Software as a Service (SaaS) applications, virtual desktops, virtual applications, web applications, mobile applications, and other forms of content. The client application 304 can include a cloud computing service, infrastructure as a service (IaaS), platform as a service (PaaS), desktop as a Service (DaaS), managed software as a service (MSaaS), mobile backend as a service (MBaaS), and information technology management as a service (ITMaaS). The client application 304 can include, but not limited to, virtual desktops, virtual applications, SaaS applications, web applications, mobile applications, and other forms of content. In some embodiments, the client application 304 can include or correspond to applications provided by remote servers or third party servers. In embodiments, the client application 304 can include or correspond to application 140 of FIG. 1A and/or SaaS applications 210 of FIGS. 2A-2B.

The client application 304 can establish a connection 342 and/or session 344 to computing device 320, hosted application 322, gateway device 330 and/or monitoring service 350 for the end point 302. The client application 304 can include at least one processor 306 that can include non-volatile memory that stores computer instructions and an operating system. The computer instructions can be executed by the processor out of volatile memory to perform all or part of the methods 400 and/or 500. In some embodiments, the client application 304 can include a non-transitory computer-readable medium, comprising instructions that, when executed by the processor of the client application 304, cause the processor to perform all or part of the methods 400 and/or 500.

The computing device 320 can include a server (e.g., host server), virtual machine, or hosted computing device providing one or more applications 322. In embodiments, the computing device 320 can include a host server(s) 320 that provides access to hosted applications 322 to end points 302 over one or more networks 340. Individual connections 342, sessions 344 or communications between host server(s) 320 and end points 302 can be monitored by a monitoring server 350, and connections or operational characteristics may be provided to a monitoring server 350 or remote server for correlating data 312 and failure mitigation. In embodiments, the computing device 320 can be the same as or substantially similar to computer 100 of FIG. 1A and/or server 195 of FIG. 1B.

The computing device 320 can be implemented using hardware or a combination of software and hardware. For example, components of the computing device 320 can include logical circuitry (e.g., a central processing unit or CPU) that responds to and processes instructions fetched from a memory unit (e.g., storage device 308). Components of the computing device 320 can include or use a microprocessor or a multi-core processor. A multi-core processor can include two or more processing units (e.g., processor 306) on a single computing component. Components of the computing device 320 can be based on any of these processors, or any other processor capable of operating as described herein. Processors can utilize instruction level parallelism, thread level parallelism, different levels of cache, etc. For example, the computing device 320 can include at least one logic device such as a computing device or server having at least one processor 306 to communicate. The components and elements of the computing device 320 can be separate components or a single component. The computing device 320 can include a memory component (e.g., storage device 308) to store and retrieve data (e.g., data 312, events 318). The memory can include a random access memory (RAM) or other dynamic storage device, coupled with the storage device 308 for storing information, and instructions to be executed by the computing device 320. The memory can include at least one read only memory (ROM) or other static storage device coupled with the storage device 308 for storing static information and instructions for the computing device 320. The memory can include a storage device 308, such as a solid state device, magnetic disk or optical disk, to persistently store information and instructions.

The computing device 320 can include a processor 306. The processor 306 can include non-volatile memory that stores computer instructions and an operating system. For example, the computer instructions can be executed by the processor 306 out of volatile memory to perform all or part of the methods 400 and/or 500. In some embodiments, the computing device 320 can include a non-transitory computer-readable medium, comprising instructions that, when executed by the processor 306 of the computing device 320, cause the processor 306 to perform all or part of the methods 400 and/or 500.

The computing device 320 can provide or host a hosted application 322. The hosted application 322 can include resources, desktops, and or files. In embodiments, the hosted application 322 can include local applications (e.g., local to a client device 302), hosted applications, Software as a Service (SaaS) applications, virtual desktops, virtual applications, web applications, mobile applications, virtual agents and other forms of content. The hosted application 322 can include a cloud computing service, infrastructure as a service (IaaS), platform as a service (PaaS), desktop as a Service (DaaS), managed software as a service (MSaaS), mobile backend as a service (MBaaS), and information technology management as a service (ITMaaS). The hosted application 322 can include, but not limited to, virtual desktops, virtual applications, SaaS applications, web applications, mobile applications, and other forms of content. In some embodiments, the hosted application 322 can include or correspond to applications provided by remote servers or third party servers. In embodiments, the hosted application 322 can include or correspond to application 140 of FIG. 1A and/or the SaaS applications 210 of FIGS. 2A-2B.

In embodiments, the hosted application 322 may provide or host an virtual desktop environment for one or more end points 302. For example, the end points 302 can connect or access virtual desktop environments hosted by the computing devices 320 by connecting to one or more hosted applications 322 that are stored and/or executed on the computing devices 320. The hosted application 322 can be or include a virtual delivery agent (VDA) or other application that enables end points 302 to access a virtual desktop that is maintained by one or more of the computing devices 320. The hosted application 322 can include at least one processor 306 that can include non-volatile memory that stores computer instructions and an operating system. The computer instructions can be executed by the processor out of volatile memory to perform all or part of the methods 400 and/or 500. In some embodiments, the hosted application 322 can include a non-transitory computer-readable medium, comprising instructions that, when executed by the processor of the hosted application 302, cause the processor to perform all or part of the methods 400 and/or 500.

In some embodiments, a gateway device 330 can be used to establish a session 344 or connection 342 between an end point 302 and a computed device 320. The gateway device 330 can include a gateway server, proxy server, router, firewall, switch, bridge or other type of computing or network device. In embodiments, the gateway device 330 can include a proxy for brokering or establishing a connection 342 and/or session 344 between one or more end points 302 and one or more computing devices 320. The gateway device 330 can include an address (e.g., internet protocol (IP) address) to identify the gateway device 330 during one or more sessions 344 to hosted applications 322. The network 340 can include one gateway device 330 or multiple gateway devices 330 to provide end points 302 access to computing devices 320 and/or servers in the network 340. In embodiments, the gateway device 330 can include or correspond to server 195 of FIG. 1B and/or the gateway service 208 of FIGS. 2A-2B.

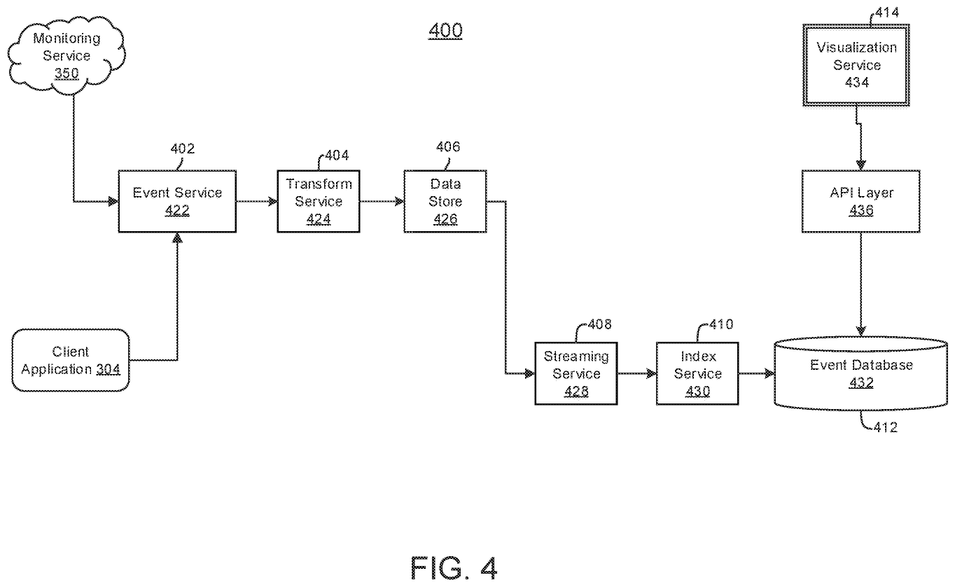

A monitoring service 350 can execute within the network 340 to monitor one or more connections 342 and sessions 344 between the end points 302 and hosted applications 322 and computing devices 320. In embodiments, the monitoring service 350 can include or connect to one or more of the components of FIG. 4. The monitoring service 350 can include a performance monitoring service or agent. The monitoring service 350 can perform data collection, aggregation, analysis, management and reporting. In embodiments, the monitoring service 350 can execute transparently (e.g., in the background) to any application 322 and/or end point 302 in the network 340. The monitoring service 350 can monitor, measure, collect, and/or analyze data 312 from end points 302, hosted applications 322 and/or computing devices 320 on a predetermined frequency, based upon an occurrence of given event(s) 218, failure 324, or in real time during operation of network 340. The monitoring service 350 can monitor resource consumption and/or performance of hardware, software, and/or communications resources of end points 302, network 340, computing devices 320 and/or hosted applications 322. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored. In embodiments, the monitoring service 350 can provide application performance management for end points 302 and/or computing devices 320.

In embodiments, the monitoring service 350 can be the same as or substantially similar to computer 100 of FIG. 1A and/or server 195 of FIG. 1B. The monitoring service 350 can be implemented using hardware or a combination of software and hardware. The components of the monitoring service 350 can include logical circuitry (e.g., a central processing unit or CPU) that responds to and processes instructions fetched from a memory unit (e.g., storage device 308). Components of the monitoring service 350 can include or use a microprocessor or a multi-core processor. A multi-core processor can include two or more processing units (e.g., processor 306) on a single computing component. Components of the monitoring service 350 can be based on any of these processors, or any other processor capable of operating as described herein. Processors can utilize instruction level parallelism, thread level parallelism, different levels of cache, etc. For example, the monitoring service 350 can include at least one logic device such as a computing device or server having at least one processor 306 to communicate. The components and elements of the monitoring service 350 can be separate components or a single component. The monitoring service 350 can include a memory component (e.g., storage device 308) to store and retrieve data (e.g., data 312, events 318, associations 326, failures 324, causes 316). The memory can include a random access memory (RAM) or other dynamic storage device, coupled with the storage device 308 for storing information, and instructions to be executed by the monitoring service 350. The memory can include at least one read only memory (ROM) or other static storage device coupled with the storage device 308 for storing static information and instructions for the monitoring service 350. The memory can include a storage device 308, such as a solid state device, magnetic disk or optical disk, to persistently store information and instructions.

The monitoring service 350 can include a processor 306. The processor 306 can include non-volatile memory that stores computer instructions and an operating system. For example, the computer instructions can be executed by the processor 306 out of volatile memory to perform all or part of the methods 400 and/or 500. In some embodiments, the monitoring service 350 can include a non-transitory computer-readable medium, comprising instructions that, when executed by the processor 306 of the monitoring service 350, cause the processor 306 to perform all or part of the methods 400 and/or 500.

The network 340 can include a public network, such as a wide area network (WAN) or the Internet, a private network such as a local area network (LAN) or a company Intranet, or a combination of a public network and a private network. The network 340 can employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network 340 can include a WiFi network. The network 340 can include a virtual private network (VPN). The VPN can include one or more encrypted connections 342 between an end point 302, monitoring service 350, computing device 320, and/or hosted application 322 over network 340 (e.g., internet, corporate network, private network). In some embodiments, an end point 302, monitoring service 350, computing device 320, and/or hosted application 322 may be on the same network 340. In some embodiments, one or more of an end point 302, monitoring service 350, computing device 320, and/or hosted application 322 may be on different networks 340. The network 34 can be the same or substantially similar to cloud 175 of FIG. 1B.

The sessions 344 can include or correspond to an application session, a browser session, a remote application session, virtual desktop session, virtual application session, and/or web application session. In embodiments, a session 344 can include a virtual desktop session from a client application 304 of an end point 302 to a hosted application 322 of a computing device 320 (e.g., virtual machine).

The connections 342 can correspond to or be used to establish an application session, a browser session, and/or a remote application session between a client application 304 of an end point 302 to a hosted application 322 of a computing device 320. The connections 342 can be established using a communication protocol, including but not limited to, IEEE 202.11 based protocol, Bluetooth based protocol, WiFi based protocol or cellular based protocol. The connections 342 can include encrypted and/or secure sessions established between a client application 304, an end point 302, a hosted application 322 and/or computing device 320. The encrypted connection 342 can include an encrypted file, encrypted data or traffic transmitted between a client application 304, an end point 302, a hosted application 322 and/or computing device 320.

The device 370 can generate one or more mappings 310. A mapping 310 can include a link or association between characteristics 314, data points, data values and/or attributes of data 312 from different sources (e.g., end point 302, client application 304, computing device 320, hosted application 322, monitoring service 350). The mapping 310 can indicate or identify a relationship between the characteristics 314. The relationship can include, but is not limited to, an association 326 and/or a match between the characteristics 314. An association 326 can include characteristics 314 having values in the same range or common range (e.g., time values 328 in same time range) and/or characteristics 314 having the same value (e.g., matching values). An association 326 can include characteristics 314 of the same type (e.g., same failure code, same failure category). In embodiments, an association 326 can include or indicate a relationship between characteristics 314, data points, data values and/or attributes of data 312 from different sources.

Data 312 can include data, metrics, values, and/or identifying information for one or more failures 324 and/or events 318 occurring in network 340. The data 312 can include data, metrics, values, and/or identifying information for one or more failures 324 and/or events 318 occurring during an attempt to establish a session 344 or connection 342 between an end point 302 and a hosted application 322, an end point 302 and a gateway device 330, and/or a gateway device 330 and a hosted application 322. The data 312 can include any information recorded or collected by an end point 302, client application 304, computing device 320, hosted application 322 and/or monitoring service 350 corresponding to or associated with a failure 324 and/or event 318.

Characteristics 314 can include an attribute, data point and/or data value of a data set 312. The characteristics 314 can include, but are not limited to, a failure code, a failure category, a failure reason, a username, client device identifier, IP address (e.g., gateway device IP address, end point IP address, monitoring server IP address, computing device IP address, hosted application IP address), type of connection (e.g., internal connection, external connection), and/or a time value 328 (e.g., time stamp, failure time).

In embodiments, a failure code characteristic 314 can indicate or identify an error code generated by a hosted application 322 and/or monitoring service 350 and can indicate an appropriate error mapping defined per platform. A failure category characteristic 314 can map or link a failure code characteristic 314 to an error category (e.g., high level category), such as but not limited to, client connection error or client socket error. A failure reason characteristic 314 can indicate or provide a detailed description of an error, failure 324 and/or event 318 generated by a hosted application 322 and/or monitoring service 350. A username characteristic 314 can include or identify an identifier of an end point 302 and/or a username of a user of an end point 302 experiencing an error, failure 324 and/or event 318. A type of connection characteristic 314 can include whether an error, failure and/or event 318 occurred on an internal connection 342 or an external connection 342. In embodiments, an address characteristic 314 can indicate an IP address of one or more devices, servers or applications included in a connection 342 or session 344. A time value 328 can indicate when an error, failure 324 and/or event 318 occurred and/or when data 312 associated with an error, failure 324 and/or event 318 was recorded at a device, server or application.

In embodiments, a failure category can include or indicate a connectivity error causing a failure 324 at or recorded by an end point 302, gateway device 330 and/or hosted application 322. The connectivity error can include or correspond to a failure 324 when an end point 302 or client application 304 is attempting to connect to a hosted application 322 through an internal connection 342 (e.g., private network) or an external connection 342 (e.g., public network, gateway device 330). In some embodiments, the connectivity error can include a client error (e.g., end point 302) through gateway device 330 due to an invalid ticket (e.g., STA ticket), a client error (e.g., end point 302) through gateway device 330 due to no reconnect ticket, a client error (e.g., end point 302) through gateway device 330 due to lookup failure, a client error (e.g., end point 302) through gateway device 330 due to a wrong or incorrect ticket format, a client error (e.g., end point 302) through gateway device 330 due to bind request parse failure, a client error (e.g., end point 302) through gateway device 330 due to no or incorrect license, a client error (e.g., end point 302) through gateway device 330 due to a DNS failure between the gateway device 330 and hosted application 322, a client error (e.g., end point 302) through gateway device 330 due to a failed connection attempt between the gateway device 330 and hosted application 322, and/or a client error (e.g., end point 302) through gateway device 330 due to a server failure at the gateway device 330. In some embodiments, a failure 324 can include a network failure or network error. The network failure can include errors during set up or connecting to a network 340. In some embodiments, the network failures can include firewall issues, firewall settings, and/or genetic socket connectivity issues. In embodiments, the network failures 324 can include, but are not limited to, a refused certificate (e.g., secure sockets layer (SSL) certificate, network unreachable, a timeout event, network unavailable, and/or invalid certificate.

In embodiments, a cause 316 can include a reason for a failure 324 and/or event 318. The cause 316 can include a device, server, or application causing the failure 324 and/or event 318. The cause 316 can include a type of connection 342 (e.g., internal connection, external connection) causing the failure 324 and/or event 318 and/or a location on a data path between an end point 302, gateway device 330 and/or hosted application 322 where the failure 324 and/or event 318. In some embodiments, the cause 316 can include or indicate a failure code, failure category and/or failure reason as indicated in data 312 received from different sources and associated through a mapping 310. In one embodiment, the cause 316 can include or indicate a failure code, failure category and/or failure reason identified in data 312 from two sources (e.g., monitoring service 350, hosted application) that match (e.g., same failure code received in both data sets) or an association 326 is determined between the two data sets received for the failure code, failure category and/or failure reason.

An event 318 can include a failure 324 or error in network 340. The end points 302, client applications 304, computing devices 320, hosted applications 322, gateway device 330 and/or monitoring service 350 can detect and record one or more events 318 and data 312 associated with one or more events 318. An event 318 can include a selection at a user interface indicating a detected anomaly was correct, restarts of end points 302 accessing hosted application 322, manual disconnections of an end point 302 from a hosted application 32205, complaints to a computing device 320 (e.g., virtual desktop provider). In embodiments, the end point 302, hosted application 322, gateway device 330 and/or monitoring service 350 can detect an event 318 indicating whether an error occurred or a failure 324 occurred (e.g., whether the error/failure determination was correct). The event 318 can include or be detected through an error notification, an error log, an API call identifying or returning an error, a loss of connection notification, a request to reestablish a lost connection or reboot a service, a negative acknowledgement of one or more packets, a device not found notification from an intermediary router, or any other such signals. The event 318 can include a failure 324 to launch a session 344 or connection 342 to a hosted application 322 from an end point 302 or from a gateway device 330 for an end point 302. In embodiments, an event 318 can include a time period or refer to a time period having one or more time values 328 and can include one or more failures 324.

The device 370 can generate one or more actions 360 and/or one or more recommendations 362. An action 360 can include a step, process or command to correct, address or repair a failure 324. In embodiments, an action 360 can include a script, code, set of instructions or command indicating one or more steps to correct, address or repair a failure 324. In embodiments, an action 360 can include but is not limited to, a new or updated certificate, a new connection 342, firewall settings, new or updated ticket (e.g., STA ticket), and/or a request to reboot or restart an end point 302, gateway device 330, computing device 320 and/or hosted application 322. In some embodiments, an action 360 can be provided or indicated in the form of a recommendation 362. The recommendation 362 can include a code, script, set of instructions or command identify one or more actions 360 to correct, address or repair a failure 324.

The device 370 can include and maintain a database 372. The database 372 can include, store and maintain one or more mappings 310 generated for one or more events 318 and one or more failures 324. The database 372 can include an entry or table indicating the associations 326 and/or matches between data sets 312 received from different sources for an event 318 and/or failure 324. In some embodiments, the database 372 can be organized by time values 328 or time ranges and one or more events 318 and/or one or more failures 324 identified during a particular time value 328 or time range. In some embodiments, the database 372 can be organized by event 318 and/or failure 324 such that an entry includes mapping 310 for an event 318 and/or failure 324 indicates or shows the links or associations 326 between characteristics 314 of data sets 312 received for the respective event 318 and/or failure 324. The database 372 can be the same as or substantially similar to storage device 308 and/or event database 432 of FIG. 4.

Now referring to FIG. 4, a method 400 for collecting and aggregating data 312 from a client application 304 and a monitoring service 350 is provided. In embodiments, the method 400 can include collecting and aggregating event streaming data in real-time. The components of method 400 can receive and/or capture data 312 (e.g., in real-time) from event sources, including but not limited to, one or more client applications 304, hosted applications 322, and the monitoring service 350 (e.g., databases, sensors, mobile devices, cloud services, software applications) in the form of event streams 318. The event streams 318 and associated data 312 can be processed and stored for later retrieval and analysis and/or the event streams 318 and associated data 312 can be analyzed, manipulated, processed and/or reacted to in real-time as the data 312 is received.

Referring now to operation (402), and in some embodiments, data 312 can be received from a client application 304, hosted application 322, gateway device 330 and/or a monitoring service 350. An event service 422 can receive data 312 from one or more sources including a client application 304 and a monitoring service 350. In some embodiments, the event service 422 can receive event streams from the sources and the event streams can include data 312 associated with one or more events 318. In some embodiments, the event service 422 can receive event streams and data 312 in real-time as the data 312 is being generated and/or recorded at the respective source. The data 312 can include event data associated with one or more events 318 occurring at or experienced by a client application 304 of an end point 302 (e.g., client device) and/or monitored by a monitoring service 350 monitoring a plurality of sessions 344 between devices 302 and applications 322 hosted by a plurality of computing devices 320 (e.g., virtual machines, serves). The events 318 can include a session 344 and/or a failure 324 of a session 344 to a hosted application 322. The data 312 can include characteristics 314 of the data 312 and/or metrics associated with an event 318.

Now referring to (404), and in some embodiments, performing extract, transform, load (ETL) operations can be performed on the data 312. In embodiments, a transform service 424 (e.g., ETL service) can extract or read data 312 from the event service 422. The transform service 424 can receive the data 312 in a stream (e.g., event stream) based in part on an event 318 the data 312 is associated with and/or continuous manner, for example, as the data 312 is received and processed at the event service 422. In some embodiments, the transform service 424 can request the data 312 for a particular event 318 or group of events 318 (e.g., two or more events 318). The transform service 424 can modify, transform or convert the data from a first format to a second format. The transform service 424 can convert the data 312 from a first format corresponding to the format the data 312 was received at the event service 422 to a second format for indexing and storing in an event database 432. In some embodiments, the transform service 424 can convert the data 312 received from multiple different sources (e.g., client application 304, monitoring service 350) into a common format such that the data 312 can be aggregated and indexed for comparison and/or identifying associations (e.g., matches) between characteristics 314 of the data 312. In embodiments, the transform service 424 can perform normalization and/or filtering of the data 312 to transform, organize or aggregate the data 312. The transform service 424 can load, write, or transmit the transformed data 312, for example, to a data store 426.

Now referring to (406), and in some embodiments, the data 312 can be stored and managed, and aggregated. The data store 426 can include a distributed data store 426 for persistently storing, managing, and processing data 312 received from the transform service 424 and/or one or more different sources (e.g., client applications 304, monitoring service 350). In embodiments, the data store 426 can store the data 312 in streams (e.g., event streams) and process the streams of data 312 in real-time or as it is received. The data store 426 can process, aggregate or organize the data 312, for example, such that the data 312 can be analyzed and processed later at a streaming service 428. In some embodiments, the data store 426 can perform event tracking, metrics collection, characteristics collection, and/or monitoring of the data 312. In one embodiment, the data store 426 can monitor and track event data and operational metrics (e.g., failures 324, latency). The data store 426 can aggregate and organize the data 312 for analysis and correlation by the streaming service 428.

Now referring to (408), and in some embodiments, the data 312 can be correlated. A streaming service 428 (e.g., streaming application, streaming layer application) can process the data 312 and/or event steams including the data to identify one or more associations 326 between the data 312 received from the application 304 and the data 312 from the monitoring service 350. The streaming service 428 can compare characteristics 314 (e.g., attributes) of the data 312 to determine associations 326 or matches between the data 312. In embodiments, the streaming service 428 can be a component of device 370 of FIG. 3 or connected to device 370 and perform one or more processes of method 500 to generate a mapping 310 between characteristics 314 of the data 312.

In embodiments, the associations 326 can include characteristics that are similar or correspond to the same event 318 and/or failure 324. The associations 326 can include time values 328 with the same time range or common time range associated with an event 318 and/or failure 324 (e.g., same time range when event or failure occurred). In embodiments, the associations 326 can include matches of characteristics 314 including, but not limited to, the same failure category, same username, same failure code and/or any type of characteristics 314 of the data 312 that is the same. In embodiments, the streaming service 428 can correlate and process the data 312 in real-time as the data 312 or event streams including the data 312 is received. The streaming service 428 can transmit or provide the correlated data 312 to an indexing service 430.

Now referring to (410), and in some embodiments, the data 312 can be indexed. An indexing service 430 can receive the data 312 from the streaming service 428 and index or sort the data, for example, for storing in an event database 432. In embodiments, the indexing service 430 can index or sort the data 312 using the identified associations 326 (e.g., matches) by the streaming service 428 and/or other characteristics 314 and attributes of the data 312. The indexing service 430 can format the data 312, for example, for storage at the event database 432 based in part on a format of the index database 432. The indexing service 430 can group or organize data 312 having one or more associations 326 (e.g., matches) into subsets for an event 318 and/or failure 324. In some embodiments, the indexing service 430 can write, store or transmit the indexed data 312 to the event database 432.

Now referring to (412), and in some embodiments, the data 312 can be stored. The event database 432 can store and maintain the data 312 based in part on an event 318 and/or failure 324 the data 312 is associated with. For example, the index database 432 can store and maintain the data in event subsets or event tables that includes different data points 312 linked together based on at least one association or match. In one embodiment, the index database 432 can link data 312 having the same failure code, failure category, time value within a common time range, username and/or other characteristics 314 of the data 312. The event database 432 can maintain a table or entry for one or more events 318, including failures 324, and store the data 312 from different sources (e.g., application 304, monitoring service 350) in the common table for the event 318. IN embodiments, the event database 432 can be a component of or connected to database 372 of FIG. 3.

In embodiments, the event database 432 can store the data 312 in chunks and/or segments based in part on a time value 328 associated with the data 312 and/or one or more characteristics 314 associated with the data 312. The event database 432 can partition or organize the data 312 into chunks with each chunk corresponding or representing a particular time range, characteristic 314 or group of characteristics 314. The data 312, based on the time value 328, that falls into that time range can be stored in the corresponding chunk. IN embodiments, the data 312 having a particular characteristic 314 can be stored in the corresponding chunk. The event database 432 can partition the chunks into segments using smaller time ranges and/or one or more characteristics 314. For example, a chunk can include one or more segments. The segments can include a smaller time range and/or smaller subset of characteristics 314.

Now referring to (414), and in some embodiments, one or more actions 360 can be generated or transmitted. A visualization service 434 can be connected to the event database 432, for example, through an API layer 436 to provide one or more actions 360 and/or recommendations 362. The visualization service 434 can generate and provide actions 360 or recommendations 362 for different events 318, for example, to correct or cure a failure 324 and/or otherwise address an event 318 experienced by a client application 304, gateway device 330 and/or hosted application 322. The visualization service 434 can store and maintain previous actions 360 (e.g., failure corrections) applied in response to one or more previous events 318 and/or failures 324. In one embodiment, the visualization service 434 can store and maintain predefined actions 360 or recommendations 362. The actions 360 can include, but are not limited to, moving a session 344 to a different computing device 320 or hosted application 322, applying new firewall settings, modifying existing firewall settings, issuing a new or updated certificate, and/or issuing a new or updated ticket (e.g., secure ticket authority (STA) ticket. The recommendations 362 can include, but are not limited to, one or more actions 360, one or more computing devices 320 to establish a new session 344 and/or one or more new firewall settings. The visualization service 434 can stream or provide the actions 360 and/or recommendations 362 to the event database 432 through the API layer 436. In embodiments, the API layer 436 can integrate or provide a connection or communications channel between the visualization service 434 and the event database 432. In embodiments, the event database 432 can store and maintain one or more actions 360 and/or one or more recommendations 362 generated for an event 318 in a table or entry for the respective event 318. The event database 432 can link or associate the actions 360 and/or the recommendations 362 with the events 318, for example, to address one or more future or subsequent events 318 having the same or similar characteristics 314.

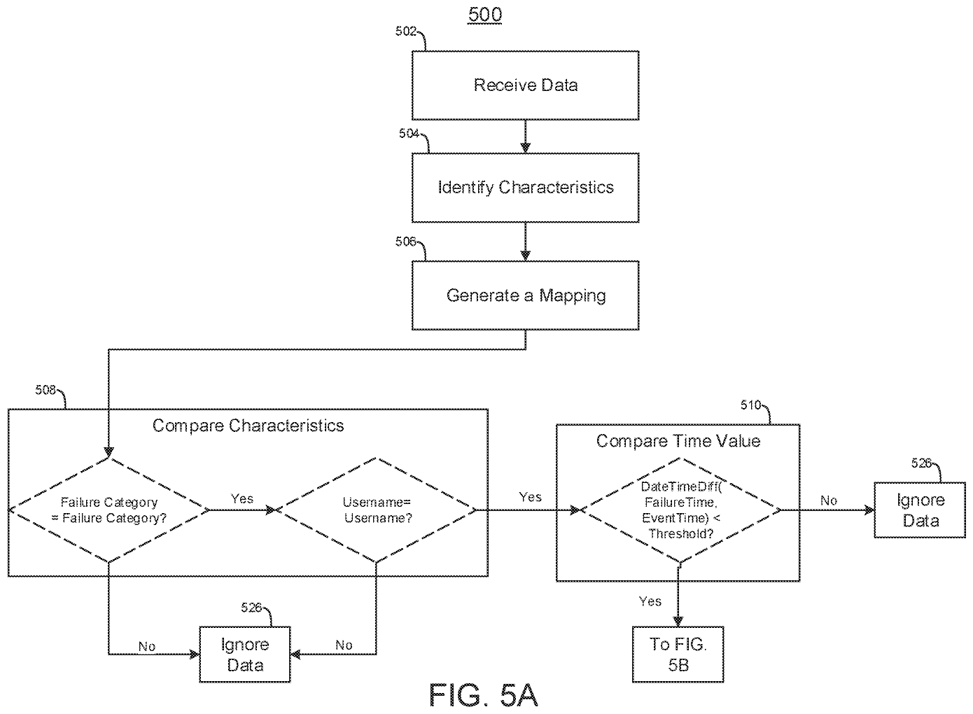

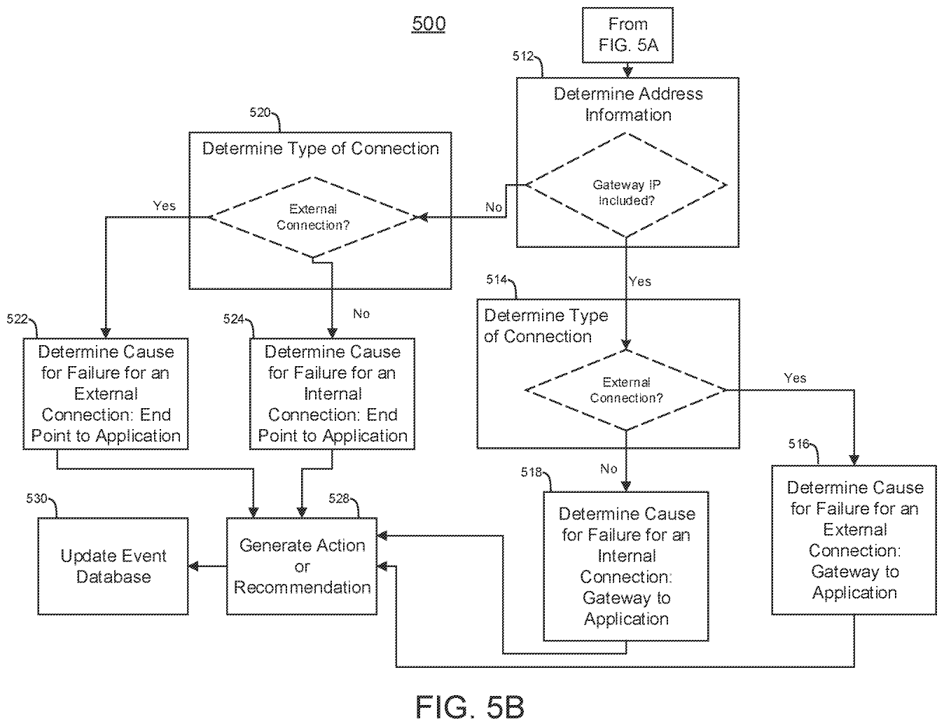

Referring now to FIGS. 5A-5B, depicted is a flow diagram of one embodiment of a method 500 for mapping data from a first source to data from one or more other sources. In brief overview, the method 500 can include one or more of: receiving data from a plurality of sources (502), identifying a failure (504), generating a mapping (506), comparing characteristics of data from the plurality of sources (508), comparing a time value associated with the data (510), determining address information associated with the data (512), determining a type of connection associated with the failure between a gateway device and a hosted application or computing device (514), determining a cause for the failure for an external connection (516), determining a cause for the failure for an internal connection (518), determining a type of connection associated with the failure between an end point and a hosted application or computing device (520), determining a cause for the failure for an external connection (522), determining a cause for the failure for an internal connection (524), ignoring data (526), generating a recommendation or action (528), and updating a database (530). The functionalities of the method 500 may be implemented using, or performed by, the components detailed herein in connection with FIGS. 1-3.

Now referring to (502), and in some embodiments, data 312 can be received from a plurality of sources. A device 370 can receive the data 312 from a variety of different sources, including but not limited to, end points 302, client applications 304, computing devices 320, hosted applications 322, gateway devices 330 and/or monitoring services 350. The device 370 can receive and organize the data 312 based in part on a time value 328 associated with the different data points, an event 318 associated with the data 312 and/or a failure 324 associated with the data 312. In one embodiment, the data 312 can received from the data store 426, as discussed with respect to FIG. 4, for processing streams of events 318 and data 312 associated with events 318.

Now referring to (504), and in some embodiments, a failure can be identified. The device 370 can identify a failure 324 or event 318 identified or included in the data 312. The failure 324 and/or event 318 can include any form of error or issue associated with establishing or maintaining a connection 342 or session 344 or a communications system error between two entities, such as but not limited to, an endpoint, a client device, control or brokering logic, gateway device, traffic proxy, remote device, and/or remote application. In embodiments, the failure 324 and/or event 318 can include an error accessing remote application, a virtual machine (e.g., virtual desktop), hosted session, a voice over internet protocol (VOIP) session or call, and/or a server. In some embodiments, the device 370 can identify a failure 324 of a session 344 with an application 322 (e.g., hosted application) of a plurality of applications 322 hosted by a computing device 320 (e.g., virtual machine) of a plurality of computing devices 320. The failure 324 of the session 344 can include a failure or error establishing a connection to the hosted application 322 from a client application 304, an end point 302 and/or gateway device 330.

Now referring to (506), and in some embodiments, a mapping 310 can be generated. The device 370 can generate a mapping 310 between characteristics 314 of data 312 from a client application 304 associated with the failure 324 and data 312 from monitoring a plurality of sessions 344 between a plurality of end points 302 and a plurality of applications 322 hosted by the plurality of computing devices 320. The device 370 can compare and correlate characteristics 314 of the data 312 received from the different sources for an event 318 and/or failure 324, for example, to verify the event 318 and/or failure 324 and to identify additional characteristics 314 for the event 318 and/or failure 324. For example, different sources can collect and/or record different characteristics 314 (e.g., metrics, attributes) of a time period, event 318 and/or failure 324 and the device 370 can receive the data 312 from the different sources to link or associate the various metrics or attributes recorded for a particular time period, event 318 and/or failure 324 from the different sources.

The device 370 can compare one or more characteristics 314 (e.g., metrics, attributes, values) of the data 312 from different sources to identify associations 326, including matches, between the characteristics 314. In embodiments, the device 370 can compare the characteristics one at a time and/or in a determined order to determine if the data 312 from the first source corresponds to the same event 318 or similar event 318 (e.g., session failure, session launch failure) as the data 312 from the second source.

Now referring to (508), and in some embodiments, characteristics 314 can be compared. In embodiments, the characteristics 314 can include, but are not limited to, a failure code, a failure category, a username associated with a user of the end point 302 or a time value 328 associated with the failure 324. The device 370 can compare a first characteristic of the data 312 from a first source (e.g., client application 304, hosted application 322, virtual application) can be compared to a first characteristic of the data 312 from a second source (e.g., monitoring service 350). The order the characteristics 314 are compared or mapped can vary and be determined based in part on the characteristics 314 included with the data 312 and/or a type of failure 324 and/or event 318.

In embodiments, the first characteristic can include or correspond to a failure category and a failure category of the data 312 from the application 322 can be compared to a failure category of the data 312 from the monitoring service 350. The device 370 can determine if an association 326 exists between the failure category of the data 312 from the client application 304 and the failure category of the data 312 from the monitoring service 350. The failure category characteristic 314 can include, but is not limited to, client connection error, client socket error, firewall setting issue at client, application or gateway, invalid ticket or certificate. The association 326 can indicate that the failure categories from both data sets corresponds to a similar event 318 (e.g., similar type failure, both firewall setting issues) and/or the association can indicate that the failure categories from both data sets are the same failure category or include the same failure category.

If an association 326 is determined between the failure category of the data 312 from the client application 304 and the failure category of the data 312 from the monitoring service 350, the method 500 can compare a second characteristic. If no association 326 is determined between the failure category of the data 312 from the client application 304 and the failure category of the data 312 from the monitoring service 350 or the failure categories do not match, the method 500 can move to (524) to ignore the event 318 associated with the data 312.

In some embodiments, a second characteristic of the data 312 from the first source (e.g., client application 304, hosted application 322, virtual application) can be compared to a second characteristic of the data 312 from the second source (e.g., monitoring service 350). The second characteristic 314 can include a different characteristic 314 from the first characteristic 314 and/or a subsequent characteristic 314 in a determined order of characteristics 314 for determining if the data 312 from the first source corresponds to the same event 318 or similar event 318 (e.g., session failure, session launch failure) as the data 312 from the second source.

In embodiments, the second characteristic 314 can include or correspond to a username (e.g., user identifier, device identifier) included with received data 312 or associated with a device (e.g., client device, virtual machine, server) providing the respective data 312. The device 370 can compare a username of the data 312 from the client application 304 to a username of the data 21 from the monitoring service 350. The device 370 can determine if an association 326 exists between the username information from the client application 304 and the monitoring service 350. The username can include, but is not limited to, a client identifier, a device identifier, and/or any form of identifier assigned to or associated with a user and/or computing device. The association 326 can indicate that the username information from both data sets is similar or corresponds to a similar event 318 (e.g., event experienced by similar users) and/or the association 326 can indicate that the username from both data sets is the same and indicate that the same user is involved (e.g., experienced same event 318, experiences same failure) and/or same device(s) are involved (e.g., experienced same event 318, experiences same failure).

The device 370 can determine an association or a plurality of associations 326 between the characteristics 314 of the data 312 from the client application 304 and the characteristics 314 of the data 312 from the monitoring. The number of associations 326 can be based in part on the similarity of data 312 (e.g., whether or not the data sets correspond to the same failure or event) and/or a number of characteristics 314 compared. In embodiments, If an association 326 is determined between the username information of the data 312 from the client application 304 and the username information of the data 312 from the monitoring service 350, the method 500 can move to (510) to compare time values 328 associated with the data 312. In some embodiments, the device 370 can determine to compare more characteristics 314 of the data 312 can stay at (508) to compare and map one or more additional characteristics 314 of the data 312 from the different sources. If no association 326 is determined between the username information of the data 312 from the application 322 and the username information of the data 312 from the monitoring service 350 or the usernames do not match, the method 500 can move to (526) to ignore the event 318 associated with the data 312.

Now referring to (510), and in some embodiments, a time value 328 can be compared. In embodiments, the time value 328 can include or correspond to a characteristic 314 of the data 312. The device 370 can compare the time values 328 of different data points within the data sets 312 from the different sources to determine an association 326 and/or match. In some embodiments, the device 370 can determine an association 326 responsive to a time value 328 of the data 312 from the client application 304 and a time value 328 of the data 312 from the monitoring (e.g., from monitoring service 350) being within a common time range. The time value 328 can be used to determine if the data 312 from a first source corresponds to the same event 318 or similar event 318 (e.g., session failure, session launch failure) as the data 312 from a second source or multiple other sources.

In embodiments, the device 370 can compare a time value 328 of the data 312 from the client application 304 to a time value 328 of the data 312 from the monitoring service 350. The device 370 can determine if an association 326 exists between the time value 328 from the client application 304 and the time value 328 from the monitoring service 350. The time value 328 can include a time when an event 318 occurred, a time when the data 312 was recorded or received, a time stamp or a time range associated with an event 318. In embodiments, different devices and/or applications can have internal clocks, time stamps and/or time mechanisms that are not calibrated or set at the same exact times and thus, data 312 recorded at different devices and/or applications for the same event 318 (e.g., same session failure) can have a different time value 328 but fall within or be associated with a common time range or the same time range (e.g., less than a minute different, within a minute range of each other). The association 326 of the time value 328 can include a time range that includes accepted time values 328 for a same event 318, similar event 318, same data 312 and/or similar data 312 or a time threshold indicating if data 312 is associated with the same event 318, similar event 318, same data 312 and/or similar data 312.

In embodiments, the device 370 can compare the time value 328 from the data 312 from the client application 304 to the time value 328 from the data 312 from the monitoring service 350 to determine if the time value 328 are the same or determine a time difference between the two time values 328. The device 370 can compare the time difference between the time values 328 to a time range or time threshold to determine if the time difference is allowable or within an allowable limit. In embodiments, the device 370 can determine an association 326 between the time values 328 of both data sets if the time values 328 are the same or the time difference between the two time values 328 is within a common time range (e.g., allowable time difference). In embodiments, the device 370 can determine or identify an event 318 identified by the client application 304 corresponds to an event 318 recorded by the monitoring (e.g., monitoring service 350) based on the association 326 between a category of the event 318, a username, and a time value 328 associated with the event 318. The event 318 can include or indicate a connection failure to the hosted application 322. If the time difference between the time values 328 is outside the time range or greater than a time threshold, the method 500 can move to (526) to ignore the data 312.

In embodiments, the device 370 can compare the time value 328 from the data 312 from the client application 304 to a time threshold for an event 318 and can compare the time value 328 from the data 312 from the monitoring service 350 to the same time threshold for the event 318. If the time values 328 from the data 312 from the client application 304 and the data 312 from the monitoring service 350 are within the time threshold for the event 318, the device 370 can determine an association 326 between the time values 328 of both data sets. In embodiments, if one of the time values 328 is outside the time threshold (or less than, or greater than), the method 500 can move to (526) to ignore the data 312.

In embodiments, the device 370 can compare the time value 328 from the data 312 from the client application 304 to a time range for an event 318 and can compare the time value 328 from the data 312 from the monitoring service 350 to the same time range for the event 318. If the time values 328 from the data 312 from the client application 304 and the data 312 from the monitoring service 350 are within the time range for the event 318, the device 370 can determine an association 326 between the time values 328 of both data sets. In embodiments, if one of the time values 328 is outside the time range, the method 500 can move to (526) to ignore the data 312. If an association 326 is determined between the time values 328, the method 500 can move to (512) to determine address information (e.g., IP address of gateway device 330) is included with or indicated by the data 312.

Referring now to (512), and in some embodiments, address information included with the data 312 can be determined. The device 3710 can determine if the data 312 includes address information for a gateway device 330, end point 302, hosted application 322 and/or computing device 320. The device 370 can determine if the data 312 includes gateway address information, an indication that a gateway device is available for a session 344 associated with the data 312, if an address (e.g., IP address) of a gateway device 330 or identifier for a gateway device 330 is included with the data 312. In embodiments, the device 370 can determine if a gateway device 330 is or was used to establish a session 344 between an end point 302 and a hosted application 322 at a hosted computing device 320 and/or a session 344 between a client application 304 of an end point 302 and a hosted application 322 at a hosted computing device 320. The device 370 can determine if the gateway device 330 attempted to launch a connection 342 to a hosted application 322 for an end point 302.

The data 312 can include gateway address information, including but not limited to, an IP address for a gateway device 330 or identifier for a gateway device 330 if a gateway device 330 is available to for an end point 302 to establish one or more sessions 344 to a hosted application 322. The data 312 can include end point address information, including but not limited to, an IP address for an end point 302, IP address for a hosted application, or address information for any device, server or application included in a connection 342 or attempt to establish a connection 342, for example, to identify where or on what data path a failure 324 and/or event 318 may have occurred. In embodiments, if no gateway address information is included with the data 312 from the application 322 or the monitoring service 350, the method 500 can move to (520), to determine a type of connection between an end point 302 and a hosted application 322 provided by a hosted computing device 320. In embodiments, if the data 312 include gateway address information, the method 500 can move to (514) to determine a type of connection between a gateway device 330 and an application 322 provided by a hosted computing device 320.

Referring now to (514), and in some embodiments, a determination can be made if the connection 342 is an internal connection 342 or external connection 342 for a connection 342 between a gateway device 330 and a hosted application 322 and/or computing device 320. The type of connection can aid in identifying a cause 316 for a failure 324 by reducing the number of potential issues or connection points that may have caused the failure 324. The device 370 can determine if a connection 342 associated with the data 312 is an internal connection 342 between a gateway device 330 and an application 322 provided by a hosted computing device 320 or an external connection 342 between a gateway device 330 and an application 322 provided by a hosted computing device 320. In some embodiments, an internal connection 342 can include a connection 342 or session 344 established through a private network 340 (e.g., company internal network) or internal network 340 and an external connection 342 can include a connection 342 or session 344 established through a public network 340 or external network 340. The device 370 can determine properties of the network 340 used to establish or attempted to establish the failed connection 342 and/or properties of the failed connection 342 to determine the type of connection. In embodiments, the device 370 can determine and use address information for an end point 302, gateway device 330 and/or hosted computing device 320 associated with the failed connection 342 to determine if the connection 342 is an internal connection 342 or an external connection 342. In embodiments, if the connection 342 is an external connection 342, the method 500 can move to (516) to determine a cause for the external connection 342. In embodiments, if the connection 342 is an internal connection 342, the method 500 can move to (518) to determine a cause for the internal connection 342.

Referring now to (516), and in some embodiments, a cause 316 for a failure 324 of an external connection can be determined. The device 370 can determine the cause 316 for the event 318 indicated by the data 312 and associated with a failure 324 of a session 344 to an application 322. The device 370 can determine, responsive to the mapping 310 indicating an association 326 between at least one characteristic 314 of the data 312 from the client application 304 and the data 312 from the monitoring, a cause 326 of the failure 324 of the session 344 and/or connection 342 with the hosted application 322. The device 370 can determine that the failure 324 was for an external connection 342 to the application 322 from the gateway device 330. In some embodiments, the device 370 can use the type of connection (e.g., external connection), failure code and/or failure category indicated by the data 312 to determine the cause 316 for the failure 324. The device 370 can determine if the failure code and/or failure category indicates an external connection 342 and/or filter the failure codes and/or failure categories received with the data 312 for ones correspond to or indicating an external connection 342.

For example, the cause 316 can include, but is not limited to, firewall settings (e.g., incorrect settings) of the gateway device 330, firewall settings of the application 322, firewall settings at a client application 304, connection launch rejected by gateway device 330, network security issues, invalid certificate or invalid ticket. In embodiments, the device 370 can determine a cause 316 for a failure 324 and event 318 associated with the data 312. The device 370 can generate a notification indicating the cause 316 to one or more of the devices or machines associated with the data 312. For example, the device 370 can generate and provide a notification to a client device 102 (e.g., for user), a gateway device 330 (e.g., for an administrator, network technicians) and/or a hosted computing device 320 (e.g., for an administrator, network technicians).

Referring now to (518), and in some embodiments, a cause 316 for a failure 324 of an internal connection 342 can be determined. The device 370 can determine the cause 316 for the event 318 indicated by the data 312 and associated with a failure 324 of a session 344 to an application 322. The device 370 can determine, responsive to the mapping 310 indicating an association 326 between at least one characteristic 314 of the data 312 from the client application 304 and the data 312 from the monitoring, a cause 326 of the failure 324 of the session 344 and/or connection 342 with the hosted application 322. The device 370 can determine that the failure 324 was for an internal connection 342 to the application 322 from the gateway device 330. In some embodiments, the device 370 can use the type of connection (e.g., internal connection), failure code and/or failure category indicated by the data 312 to determine the cause 316 for the failure 324. The device 370 can determine if the failure code and/or failure category indicates an internal connection 342 (e.g., private network, internal network) and/or filter the failure codes and/or failure categories received with the data 312 for ones correspond to or indicating an external connection 342.

For example, the cause 316 can include, but is not limited to, firewall settings (e.g., incorrect settings) of the gateway device 330, firewall settings of the application 322, connection launch rejected by gateway device 330, network security issues or invalid certificate. In embodiments, the device 370 can determine a cause 316 for a failure 324 and event 318 associated with the data 312. The device 370 can generate a notification indicating the cause 316 to one or more of the devices or machines associated with the data 312. For example, the device 370 can generate and provide a notification to a client device 102 (e.g., for user), a gateway device 330 (e.g., for an administrator, network technicians) and/or a hosted computing device 320 (e.g., for an administrator, network technicians).

Referring now to (520), and in some embodiments, a determination can be made if the connection 342 is an internal connection 342 or external connection 342 (e.g., independent of a gateway device) for a connection 342 between an end point 302, client application 304 and a hosted application 322 and/or computing device 320. The device 370 can determine if a connection 342 associated with the data 312 is an internal connection 342 between an end point 302 and an application 322 provided by a hosted computing device 320 or an external connection 342 between an end point 302 and an application 322 provided by a hosted computing device 320. In some embodiments, an internal connection 342 can include a connection 342 or session 344 established through a private network 340 (e.g., company internal network) or internal network 340 and an external connection 342 can include a connection 342 or session 344 established through a public network 340 or external network 340. The device 370 can determine properties of the network 340 used to establish the connection 342 between the end point 302 and hosted computing device 320 or that a request to launch a connection 342 between the end point 302 and hosted computing device 320 was received through. In embodiments, the device 370 can determine and use address information for an end point 302 and/or hosted computing device 320 associated with the failed connection 342 to determine if the connection 342 is an internal connection 342 or an external connection 342. In embodiments, if the connection 342 is an external connection 342, the method 500 can move to (520) to determine a cause for the external connection 342. In embodiments, if the connection 342 is an internal connection 342, the method 500 can move to (522) to determine a cause for the internal connection 342.

Referring now to (522), and in some embodiments, a cause 316 for a failure 324 for an external connection can be determined. The device 370 can determine the cause 316 for the event 318 indicated by the data 312 and associated with a failure 324 of a session 344 to an application 322. The device 370 can determine, responsive to the mapping 310 indicating an association 326 between at least one characteristic 314 of the data 312 from the client application 304 and the data 312 from the monitoring, a cause 326 of the failure 324 of the session 344 and/or connection 342 with the hosted application 322. The device 370 can determine that the failure 324 was for an external connection 342 to the application 322 from the end point 302, for example, through a public network 340 or external network 340. In some embodiments, the device 370 can use the type of connection (e.g., external connection), failure code and/or failure category indicated by the data 312 to determine the cause 316 for the failure 324. The device 370 can determine if the failure code and/or failure category indicates an external connection 342 and/or filter the failure codes and/or failure categories received with the data 312 for ones correspond to or indicating an external connection 342. For example, the cause 316 can include, but is not limited to, firewall settings (e.g., incorrect settings) at the end point 302, firewall settings of the application 322, connection launch rejected by application 322, network security issues or invalid ticket. In embodiments, the device 370 can determine a cause 316 for a failure 324 and event 318 associated with the data 312. The device 370 can generate a notification indicating the cause 316 to one or more of the devices or machines associated with the data 312. For example, the device 370 can generate and provide a notification to a client device 102 (e.g., for user), and/or a hosted computing device 320 (e.g., for an administrator, network technicians).

Referring now to (524), and in some embodiments, a cause 316 for a failure 324 for an internal connection 342 can be determined. The device 370 can determine the cause 316 for the event 318 indicated by the data 312 and associated with a failure 324 of a session 344 to an application 322. The device 370 can determine, responsive to the mapping 310 indicating an association 326 between at least one characteristic 314 of the data 312 from the client application 304 and the data 312 from the monitoring, a cause 326 of the failure 324 of the session 344 and/or connection 342 with the hosted application 322. The device 370 can determine that the failure 324 was for an internal connection 342 to the application 322 from the end point 302, for example, through a private network 340 or internal network 340. In some embodiments, the device 370 can use the type of connection (e.g., internal connection), failure code and/or failure category indicated by the data 312 to determine the cause 316 for the failure 324. The device 370 can determine if the failure code and/or failure category indicates an internal connection 342 (e.g., private network, internal network) and/or filter the failure codes and/or failure categories received with the data 312 for ones correspond to or indicating an external connection 342. For example, the cause 316 can include, but is not limited to, firewall settings (e.g., incorrect settings) of the end point 302, firewall settings of hosted computing device 320, firewall settings of the application 322, connection launch rejected by hosted computing device 320 or network security issues. In embodiments, the device 370 can determine a cause 316 for a failure 324 and event 318 associated with the data 312. The device 370 can generate a notification indicating the cause 316 to one or more of the devices or machines associated with the data 312. For example, the device 370 can generate and provide a notification to a client device 102 (e.g., for user) and/or a hosted computing device 320 (e.g., for an administrator, network technicians).

Referring now to (526), and in some embodiments, the data 312 and/or event 318 can be ignored. The device 370 can determine that the data 312 received from the application 322 and received from the monitoring service 350 does not correspond to the same event 318. The device 370 can determine that there is an issue with the data 312 or that the data 312 may incorrectly indicate a failure 324 due to a recording or monitoring issue at the application 322 and/or monitoring service 350. Therefore, the data 312 may be unreliable. The device 370 can determine that one or more characteristics of the data 312 received from the application 322 and received from the monitoring service 350 does not match or correspond. In embodiments, the device 370 can determine here are no associations 326 between the data 312 received from the application 322 and the data 312 received from the monitoring service 350. The device 370 can ignore or not map the data 312 from the application 322 to the data 312 from the monitoring service 350.

Now referring to (528), and in some embodiments, the device 370 can generate an action 360 or recommendation 362. The action 360 or recommendation 362 can be generated to correct, address or stop a failure 324 from occurring for a subsequent connection launch attempt. In embodiments, the device 370 can use the cause 316 of the failure 324 to generate an action 360 or recommendation 362 to address or fix the issue causing the failure 324. The action 360 can include a code, script, set of instructions or command to cause a device to perform some action to address or fix the issue causing the failure 324. The action 360 can vary and be selected based at least in part on a type of setting, system update or modification to be made at a respective device (e.g., end point 302, gateway device 330, hosted computing device 320).

In embodiments, if the cause 316 of the failure 324 was due to incorrect firewall settings, the action 360 can include new or updated firewall settings to allow or enable a connection 342 between the gateway device 330 and the application 322. In embodiments, if the cause 316 of the failure 324 was due to a connection issue at an end point 302, the action 360 can include a notification to a user of the end point 302 to check a network cable or internet connection (e.g., WiFi connection) and request a system re-start at the end point 302. In embodiments, if the cause 316 of the failure 324 was due to an invalid certificate, the action 360 can include a new or updated certificate to be provided with a subsequent request to establish a connection 342.

In some embodiments, the device 370 can access a visualization service 434 to receive or request an action 360 or recommendation 362 for an identified cause 316 of a failure 324. The visualization service 434 can generate and provide actions 360 or recommendations 362 for different events 318, for example, to correct or cure a failure 324 and/or otherwise address an event 318 experienced by a client application 304, gateway device 330, and/or hosted application 322. The visualization service 434 can store and maintain previous actions 360 (e.g., failure corrections) applied in response to one or more previous events 318 and/or failures 324. The actions 360 can include, but are not limited to, moving a session 344 to a different computing device 320 and/or hosted application 322, applying new firewall settings, modifying existing firewall settings, issuing a new or updated certificate, and/or issuing a new or updated ticket (e.g., secure ticket authority (STA) ticket. The recommendations 362 can include, but are not limited to, one or more actions 360, one or more computing devices 320 to establish a new session 344 and/or one or more new firewall settings.

Referring now to (530), and in some embodiments, a database 372 can be updated. The device 370 can update a database 372 to include the data 312 received from the different sources. The device 370 can add the mapping 310 generated for the characteristics 314 of the data 312 and/or one or more associations 326 determined between the characteristics 314. The device can maintain the database 372 to include one or more mappings 310 generated for one or more events 318 and one or more failures 324. The database 372 can include an entry or table indicating the associations 326 and/or matches between data sets 312 received from different sources for an event 318 and/or failure 324. The device 370 can organize or arrange the data 312 in the database 372 by time values 328 or time ranges and one or more events 318 and/or one or more failures 324 identified during a particular time value 328 or time range. In embodiments, the device 370 can organize or arrange the data 312 in the database 372 can be organized by event 318 and/or failure 324 such that an entry includes mapping 310 for an event 318 and/or failure 324 indicates or shows the links or associations 326 between characteristics 314 of data sets 312 received for the respective event 318 and/or failure 324. The database 372 can be the same as or substantially similar to storage device 308 and/or event database 432 of FIG. 4.

In embodiments, the device 370 can determine or generate, using the updated database 372, metrics for failures 324 and/or events 318. The device 370 can determine and generate metrics including a number of failures 324 to a hosted application 322, a number of failures 324 for an end point 302, a number of failures 324 to a gateway device 330, a number of failures 324 to a computing device 320, and/or a type of connection 342 associated with the failures 324. In some embodiments, the device 370 can graph or display the failure metrics through an interface (e.g., user interface 125 of FIG. 1, GUI 150 of FIG. 1) of the device 370, end point 302 and/or computing device 320 to show and display the failure metrics and/or failure trends to a user and/or administrator. The device 370 can use the mappings 310 and associations 326 to determine which devices, servers and/or applications are experiencing failures 324 and why the failures 324 are occurring. The device 370 can map or show the performance of an end point 302, gateway device 330, hosted application 322 and/or computing device 320 after an action 360 has been applied or implemented to determine if the action 360 worked and/or an effectiveness of the action 360 (e.g., did action 360 correct a failure 324). The device 370 can store and record an effectiveness of one or more actions 360 to determine whether to apply the same or similar actions 360 to the same or similar failures 324 in the future.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

1. A method comprising:
identifying, by a device, a failure of a session established between an end point and an application of a plurality of applications hosted by a computing device of a plurality of computing devices, the computing device different from the device;
generating, by the device, a mapping that links characteristics of the data received from the application associated with the failure of the established session with data for an event associated with the failure received from monitoring a plurality of sessions between a plurality of end points and the plurality of applications hosted by the plurality of computing devices;
comparing, by the device, the characteristics of the data received from the application of the established session with characteristics of the data from the plurality of sessions that are mapped to the characteristics of the data from the application of the established session, the characteristics including at least one of a username, a time value associated with the event, an internet protocol address, or a type of connection; and
determining, by the device responsive to the comparison indicating an association between at least one characteristic of the data from the application and the data from the monitoring, a cause of the failure of the session established between the end point and the application.

2. The method of claim 1, comprising:
determining, by the device, a plurality of associations between the characteristics of the data from the application and the characteristics of the data from the monitoring.

3. The method of claim 2, wherein the characteristics include at least one of: a failure code, a failure category, a username associated with a user of the end point or a time value associated with the failure.

4. The method of claim 1, comprising:
determining, by the device, an event identified by the application corresponds to the event recorded by the monitoring based on the association between a category of the event, the username, and the time value associated with the event, wherein the event indicates a connection failure to the application.

5. The method of claim 1, comprising:
determining, by the device, the association responsive to a time value of the data from the application and a time value of the data from the monitoring being within a common time range.

6. The method of claim 1, comprising:
determining, by the device, the type of connection that caused the failure of the session with the application, the type of connection including an internal connection or an external connection.

7. The method of claim 1, comprising:
determining, by the device, the cause of the failure includes at least one of: a firewall setting at the end point of the plurality of end points, a firewall setting at the application, an issue with a certificate of the end point, or an invalid ticket.

8. The method of claim 1, comprising:
identifying, by the device, an address of a gateway device associated with the session with the application; and
determining, by the device, the failure occurred on a connection between the gateway device and the application.

9. The method of claim 1, comprising:
updating, by the device, a database to include the data from the application and the data from the monitoring for the failure; and
determining, by the device responsive to the updated database, a number of failures to the application and a type of connection that failed for each failure to the application.

10. A system comprising:
a device comprising one or more processors coupled to memory, the device configured to:
identify a failure of a session established between an end point and an application of a plurality of applications hosted by a computing device of a plurality of computing devices, the computing device different from the device;
generate a mapping that links characteristics of data received from the application associated with the failure of the established session with data for an event associated with the failure received from monitoring a plurality of sessions between a plurality of end points and the plurality of applications hosted by the plurality of computing devices;
compare the characteristics of the data received from the application of the established session with characteristics of the data from the plurality of sessions that are mapped to the characteristics of the data from the application of the established session, the characteristics including at least one of a username, a time value associated with the event, an internet protocol address, or a type of connection; and
determine, responsive to the comparison indicating an association between at least one characteristic of the data from the application and the data from the monitoring, a cause of the failure of the session established between the end point and the application.

11. The system of claim 10, wherein the device is configured to:
determine a plurality of associations between the characteristics of the data from the application and the characteristics of the data from the monitoring.

12. The system of claim 11, wherein the characteristics include at least one of: a failure code, a failure category, a username associated with a user of the end point or a time value associated with the failure.

13. The system of claim 10, wherein the device is configured to:
determine an event identified by the application corresponds to the event recorded by a monitoring service based on a match between a category of the event, the username, and the time value associated with the event, wherein the event indicates a connection failure to the application.

14. The system of claim 10, wherein the device is configured to:
determine the association responsive to a time value of the data from the application and a time value of the data from the monitoring being within a common time range.

15. The system of claim 10, wherein the device is configured to:
determine the type of connection that caused the failure of the session with the application, the type of connection including an internal connection or an external connection.

16. The system of claim 10, wherein the device is configured to:
determine the cause of the failure includes at least one of: a firewall setting at the end point of the plurality of end points, a firewall setting at the application, an issue with a certificate of the end point, or an invalid ticket.

17. The system of claim 10, wherein the device is configured to:
identify an address of a gateway device associated with the session with the application; and
determine the failure occurred on a connection between the gateway device and the application.

18. The system of claim 10, wherein the device is configured to:
update a database to include the data from the application and the data from the monitoring for the failure; and
determine, responsive to the updated database, a number of failures to the application and a type of connection that failed for each failure to the application.

19. A non-transitory computer-readable medium, comprising instructions that, when executed by a processor of a device, cause the processor to:
identify a failure of a session established between an end point and an application of a plurality of applications hosted by a computing device of a plurality of computing devices;
generate a mapping that links characteristics of data received from the application associated with the failure of the established session with data for an event associated with the failure received from monitoring a plurality of sessions between a plurality of end points and the plurality of applications hosted by the plurality of computing devices;
compare the characteristics of the data received from the application of the established session with characteristics of the data from the plurality of sessions that are mapped to the characteristics of the data from the application of the established session, the characteristics including at least one of a username, a time value associated with the event, an internet protocol address, or a type of connection; and
determine, responsive to the comparison indicating an association between at least one characteristic of the data from the application and the data from the monitoring, a cause of the failure of the session established between the end point and the application.

20. The computer-readable medium of claim 19, further comprising instructions that cause the processor to:
determine a plurality of associations between the characteristics of the data from the application and the characteristics of the data from the monitoring, wherein the characteristics include at least one of: a failure code, a failure category, a username associated with a user of the end point or a time value associated with the failure.
